(19) United States
(12) Patent Application Publication
(10) Pub. No.: US 2023/0136465 A1
(43) Pub. Date: May 4, 2023

(54) PLANT-BASED CHICKEN FLAVORING AGENT COMPOSITION

(71) Applicant: NotCo Delaware, LLC, Santiago (CL)

(72) Inventors: Rodrigo A. Contreras, Santiago (CL); Romina Montealegre, Santiago (CL); Rodrigo Muñoz-González, Santiago (CL); Ana Batista-Gonzalez, Santiago (CL); Julia Christin Berning, Santiago (CL); Sofía Yasky, Santiago (CL); Diva Aranda-Oyarzún, Santiago (CL); David G. Moya, Santiago (CL)

(21) Appl. No.: 17/944,664

(22) Filed: Sep. 14, 2022

Related U.S. Application Data
(60) Provisional application No. 63/250,496, filed on Sep. 30, 2021.

(51) Int. Cl. A23L 27/12; A23L 27/10; A23L 27/00

(52) U.S. Cl. CPC A23L 27/13; A23L 27/10; A23L 27/88; A23L 27/84

(57) ABSTRACT

Techniques to mimic chicken flavor are disclosed. A plant-based chicken flavoring agent includes a Prunus persica (Rosaceae family) component and a Zea mays (Poaceae family) component. The Prunus persica component may include an aqueous extract of peach, and the Zea mays component may include an aqueous extract of sweetcorn. A ratio of the Prunus persica component to the Zea mays component in the flavoring agent is one to an amount within a range of 1.8 and 2.2. The agent may be added to a food product to mask a flavor of the food product, to provide chicken-like flavoring, or both.

### BENEFIT CLAIM

This application claims the benefit under 35 U.S.C. § 119(e) of provisional application 63/250,496, filed Sep. 30, 2021, entire contents of which are hereby incorporated herein by reference for all purposes as if fully set forth herein.

### TECHNICAL FIELD

The disclosure generally relates to plant-based chicken flavoring agents and manufacturing thereof. One technical field is food science. Another technical field is artificial intelligence and machine learning, as applied to food.

### BACKGROUND

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

Production of animal-based foods (e.g., dairy-based foods, eggs, meat, etc.) can have a large number of requirements that can undermine society's ability to achieve sustainable, global food security, especially in the context of a growing population that is expected to reach at least 9 billion in 2050. In particular, raising of livestock and associated water requirements can contribute to greenhouse gas emissions, deforestation of forests for production of pastures for livestock production, and erosion of land due to overgrazing. As such, replacing animal-based food products with plant-based substitutes can lower the environmental impact.

One animal-based food product is chicken. Chicken has played a large role in our diets as people trade red meat for more poultry. However, this appetite for chicken is a cause for concern as chicken production has devastating environmental impacts. Furthermore, chickens are unfortunately subjected to some of the most inhumane treatments of any farmed animals.

The plant-based food industry has been growing in recent years. Cultural changes in consumers due to multiple factors, such as reduction of cruelty to animals, reduction of greenhouse gas emissions, better land use and optimizing efficiency of water use, have allowed sustained growth in plant-based food products. However, a current challenge is to replicate flavors of traditionally developed food products based on animals, such as chicken.

Accordingly, there is a need for a plant-based chicken flavoring agent.

### SUMMARY

The appended claims may serve as a summary of the invention.

### BRIEF DESCRIPTION OF THE FIGURES

FIG. 1 illustrates an example composition of a plant-based chicken flavoring agent, in accordance with some embodiments.

FIG. 2A illustrates an example method of preparing an aqueous extract of an ingredient of the plant-based chicken flavoring agent, in accordance with some embodiments.

FIG. 2B illustrates a FTIR spectrum of freeze dried peach extract.

FIG. 2C illustrates a FTIR spectrum of freeze dried sweet corn extract.

FIG. 3 illustrates an example method of preparing the plant-based chicken flavoring agent, in accordance with some embodiments.

FIG. 4 illustrates an experimental design for trained sensorial panel evaluations.

FIG. 5 illustrates an example method of preparing a plant-based chicken-like substitute, in accordance with some embodiments.

FIGS. 6A-6E illustrate results of a sensory analysis of an animal-based target (cooked chicken) and different samples.

FIG. 6F illustrates a FTIR spectrum of cooked chicken.

FIG. 7 illustrates a block diagram of a computing device in which the example embodiment(s) of the present invention may be embodiment.

FIG. 8 illustrates a block diagram of a basic software system for controlling the operation of a computing device.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

Embodiments are described herein in sections according to the following outline:
1.0 GENERAL OVERVIEW
2.0 PLANT-BASED CHICKEN FLAVORING AGENT COMPOSITION
3.0 SENSORY ANALYSIS
4.0 ARTIFICIAL INTELLIGENCE AND MACHINE LEARNING
5.0 CHEMICAL ANALYSIS
6.0 PROCEDURAL OVERVIEW
7.0 HARDWARE OVERVIEW
8.0 SOFTWARE OVERVIEW
9.0 OTHER ASPECTS OF DISCLOSURE

### 1.0 GENERAL OVERVIEW

A frequent topic discussed among consumers and food developers is the possible side effects of using synthetic chemicals, such as preservatives and flavoring agents, present in plant-based food products, on both health and environment.

Although there exists natural alternatives, traditional processes for manufacturing flavoring agents are based on a combination of purified or semi-purified organic molecules obtained or extracted from raw materials of natural origin, usually from microorganisms, fungi or algae, which are costly and difficult to obtain. These traditional processes involve access of wild plant species to extract active molecules, extracts, and/or essential oils. For example, saponins is extracted from Quillaja saponaria; boldine is extracted from Peumus boldus; azadirachtin is extracted from neem. Not only do these traditional processes require access to raw materials that may be expensive or hard to obtain, these traditional processes also require purification, which unfortunately generate byproducts (residues, waste).

Techniques described herein relate to a plant-based chicken flavoring agent and a method of manufacturing thereof. The plant-based chicken flavoring agent is a composition that includes a Prunus persica (Rosaceae family) component and a Zea mays (Poaceae family) component. In an embodiment, the Prunus persica component includes an aqueous extract of peach (e.g., clingstone peach, freestone peach, nectarine, peento peach, etc.), and the Zea mays component includes an aqueous extract of sweetcorn (e.g., yellow se corn, white se corn, bicolor se corn, etc.). In an embodiment, a ratio of the Prunus persica component to the Zea mays component in the composition is one to an amount within a range of 1.8 and 2.2. In a specific example, the ratio of the Prunus persica component to the Zea mays component in the composition is 1:1.8. In a specific example, the ratio of the Prunus persica component to the Zea mays component in the composition is 1:1.9. In a specific example, the ratio of the Prunus persica component to the Zea mays component in the composition is 1:2. In a specific example, the ratio of the Prunus persica component to the Zea mays component in the composition is 1:2.1. In a specific example, the ratio of the Prunus persica component to the Zea mays component in the composition is 1:2.2. The composition may be mixed thoroughly until a homogenous mixture is obtained. The composition and/or the mixture may be added to food products to mask flavors of the food products and/or provide chicken-like flavoring.

As further discussed herein, novelties and benefits of the present invention include the novel use of two plant species (which are affordable and easily accessible) that had not been used previously to provide as a chicken flavoring agent. The techniques described herein do not require a purification step, thereby eliminating generation of byproducts.

Other embodiments, aspects, and features will become apparent from the reminder of the disclosure as a whole.

### 2.0 PLANT-BASED CHICKEN FLAVORING AGENT

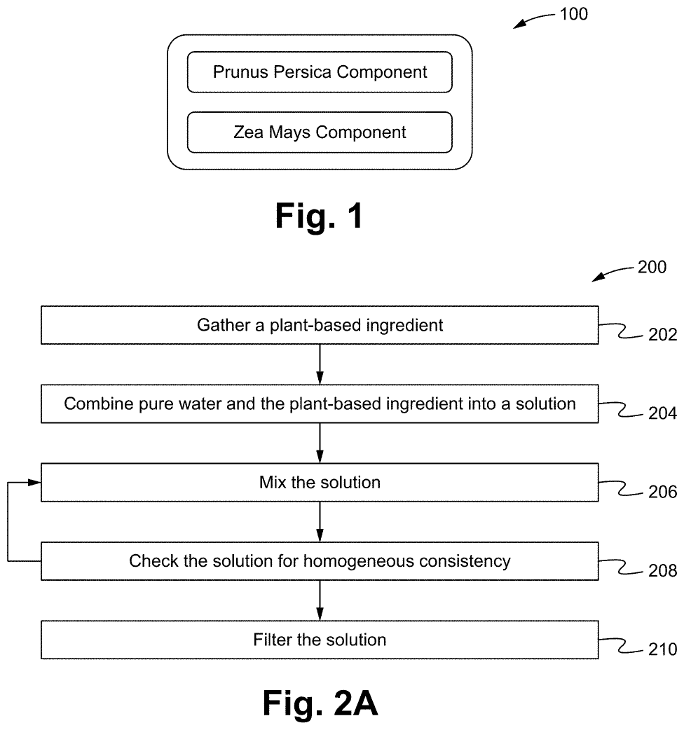

FIG. 1 illustrates an example composition of a plant-based chicken flavoring agent 100, in accordance with some embodiments. The plant-based chicken flavoring agent composition includes a Prunus persica component and a Zea mays component.

The plant-based chicken flavoring agent 100 is based on a mixture of the Prunus persica component and the Zea mays component. In an embodiment, a ratio of the Prunus persica component to the Zea mays component in the composition is one to an amount within a range of 1.8 and 2.2. In a specific example, the plant-based chicken flavoring agent 100 includes a 1:1.8 ratio of the Prunus persica component to the Zea mays component. In a specific example, the plant-based chicken flavoring agent 100 includes a 1:1.9 ratio of the Prunus persica component to the Zea mays component. In a specific example, the plant-based chicken flavoring agent 100 includes a ratio 1:2 ratio of the Prunus persica component to the Zea mays component. In a specific example, the plant-based chicken flavoring agent 100 includes a 1:2.1 ratio of the Prunus persica component to the Zea mays component. In a specific example, the plant-based chicken flavoring agent 100 includes a 1:2.2 ratio of the Prunus persica component to the Zea mays component.

In an embodiment, the Prunus persica component includes an aqueous extract of Prunus persica (e.g., clingstone peach, freestone peach, nectarine, peento peach, etc.), and the Zea mays component includes an aqueous extract of Zea mays (e.g., yellow se corn, white se corn, bicolor se corn, etc.).

In an embodiment, the aqueous extract of Prunus persica and the aqueous extract of Zea mays may be previously prepared and freeze dried for later use in preparing the plant-based chicken flavoring agent and/or in preparing a plant-based chicken-like substitute described in FIG. 5. Freeze drying an aqueous extract preserves the liquid for later use.

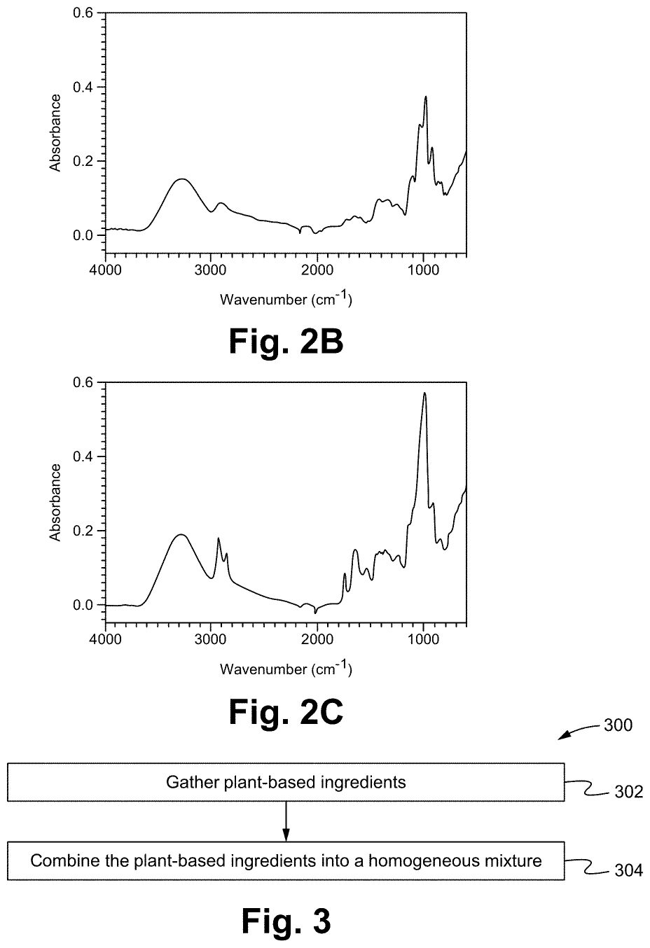

FIG. 2A illustrates an example method 200 of preparing an aqueous extract of an ingredient (component) of the plant-based chicken flavoring agent, in accordance with some embodiments. Method 200 may be repeated to prepare an aqueous extract of Prunus persica and an aqueous extract of Zea mays.

At Step 202, a plant-based ingredient is gathered. For example, the plant-based ingredient is Prunus persica or is Zea mays. The plant-based ingredient is a consumable portion (e.g., the flesh) of the plant-based ingredient.

At Step 204, pure water is combined with the plant ingredient. Pure water is water that has been processed to remove chemical contaminants (e.g., distillation, reverse osmosis, ion exchange system, etc.). In an embodiment, a proportion (ratio) of the plant ingredient to water is one to an amount within a range of 1.5 and 2.5. In a specific example, the proportion of the plant ingredient to water is 1 to an amount within a range of 1.75 to 2.25. In a specific example, the proportion of the plant ingredient to water is 1 to an amount within a range of 1.9 to 2.1. In a specific example, the proportion of the plant ingredient to water is 1 to 2.

At Step 206, the combination of water and the plant ingredient is mixed into a homogeneous solution using a dispersing instrument. Example dispersing instrument is an Ultra-Turrax homogenizer. The plant ingredient and water is mixed until the solution is homogeneous. In a specific example, the solution is mixed for approximately 5 minutes at a speed of at least 20,000 rpm. In a specific example, the solution is mixed for approximately 5 minutes at a speed of at least 25,000 rpm. In a specific example, the solution is mixed for approximately 5 minutes at a speed of at least 30,000 rpm. It is noted that different mixing intensities and different mixing times are contemplated as they are dependent on the dispersing instrument used. In an embodiment, the combination of water and the plant ingredient is mixed until particles in the solution are no larger than 8 μm in size.

At Step 208, the solution is checked for homogeneity. If the solution does not have a homogeneous consistency, then Step 206 is repeated.

Once the solution has a homogeneous consistency, then at Step 210, the solution is filtered to remove particles larger than 8 μm in size. In an embodiment, Whatman® qualitative filter paper, Grade 2 can be used to filter the solution to obtain an extract of the plant-based ingredient.

The plant extract (from Step 210) may be used to create a plant-based chicken flavoring agent that replicates (mimics) chicken flavor. In addition, the plant extract can be freeze dried using a lyophilization technique or another suitable freeze drying technique. The freeze dried plant extract can be stored for later use, such as when preparing a plant-based chicken-like substitute described in FIG. 5. In an embodiment, the freeze dried plant extract may be in powder form.

Tables 1 and 2 show characteristics of freeze dried peach extract. FIG. 2B illustrates a Fourier transform infrared (FTIR) spectrum of freeze-dried peach extract.

TABLE 1

| Parameter | Description |
|---|---|
| Appearance | Powder |
| Color | Pale yellow |
| Moisture | <7% |
| pH (0.001%) | 4.3 |

TABLE 2

| | Nutrient Contents | | Daily Nutrient Reference Values |
|---|---|---|---|
| Items | (per 100 g) | | (based on 2000 kcal/day) |
| Sodium (Na) | 0 | mg | 0% |
| Protein | 0.5 | g | 0.8% |
| Dietary Fiber | 1.2 | g | 4.2% |
| Total Fat | 0.1 | g | 0.2% |
| Total Carb | 12.8 | g | 4% |
| Energy | 54 | KCal | 3.0% |
| Cholesterol | 0 | mg | 0% |
| Vitamin A | 15 | Ug/RE | 1% |
| Vitamin C | 9 | mg | 15% |
| Calcium | 0 | mg | 0% |
| Phosphor(P) | 7 | mg | 1% |

Tables 3 and 4 show characteristics of freeze dried sweet corn extract. FIG. 2C illustrates a FTIR spectrum of freeze-dried sweet corn extract.

TABLE 3

| Parameter | Description |
|---|---|
| Appearance | Powder |
| Color | Pale yellow |
| Moisture | <7% |
| pH (0.002%) | 7.00 |

TABLE 4

| | Nutrient Contents | | Daily Nutrient Reference Values |
|---|---|---|---|
| Items | (per 100 g) | | (based on 2000 kcal/day) |
| Sodium (Na) | 3.3 | mg | 0.2% |
| Protein | 8.7 | g | 14.5% |
| Dietary Fiber | 6.4 | g | 25.6% |
| Total Fat | 3.8 | g | 6.3% |
| Total Carb | 66.6 | g | 22% |
| Energy | 335 | KCal | 16.7% |
| Cholesterol | 0 | mg | 0% |
| Vitamin A | 17 | Ug/RE | 0.8% |
| Vitamin C | 0 | mg | 0% |
| Calcium | 14 | mg | 1.8% |
| Phosphor(P) | 2.4 | mg | 16% |

FIG. 3 illustrates an example method 300 of preparing the plant-based chicken flavoring agent, in accordance with some embodiments.

At Step 302, ingredients of the plant-based chicken flavoring agent are gathered. For example, Prunus persica extract and Zea mays extract are gathered. Each of the extracts may be prepared according to method 200 of FIG. 2. In an embodiment, the extracts may be in freeze dried forms.

In an embodiment, a ratio of the Prunus persica extract to the Zea mays extract in the composition is one to an amount within a range of 1.8 and 2.2. In a specific example, the ratio of the ingredients is 1:1.8 of the Prunus persica extract to the Zea mays extract. In a specific example, the ratio of the ingredients is 1:1.9 of the Prunus persica extract to the Zea mays extract. In a specific example, the ratio of the ingredients is 1:2 of the Prunus persica extract to the Zea mays extract. In a specific example, the ratio of the ingredients is 1:2.1 of the Prunus persica extract to the Zea mays extract. In a specific example, the ratio of the ingredients is 1:2.2 of the Prunus persica extract to the Zea mays extract.

At Step 304, the ingredients are homogenously mixed, resulting in the plant-based chicken flavoring agent.

The plant-based chicken flavoring agent (from Step 304) may be added to food product(s) to mask flavor(s) of the food product(s) and/or to provide chicken-like flavoring. In addition, the plant-based chicken flavoring agent can be freeze dried using a lyophilization technique or another suitable freeze drying technique. The freeze dried plant-based chicken flavoring agent can be stored for later use, such as when preparing a plant-based chicken-like substitute described in FIG. 5. In an embodiment, the freeze dried plant-based chicken flavoring agent may be in power form.

The method 300 of preparing the plant-based chicken flavoring agent advantageously do not generate any byproducts, unlike traditional processes.

### 3.0 SENSORY ANALYSIS

To determine the relevance of the ingredients (e.g., Prunus persica extract and Zea mays extract) of the plant-based chicken flavoring agent, a sensory analysis was carried out by a trained panel. Four groups of plant-based chicken-like substitutes, each with none, one, or both of the ingredients of the flavoring agent, were evaluated. Results from the sensory analysis, as further discussed herein, show that an application of both ingredients in certain proportions give an attribute of chicken flavor.

Plant-based chicken-like substitutes evaluated in the sensory analysis each comprises base ingredients of a plant-based chicken-like meat that together mimic texture and color of chicken (animal-based target). In an embodiment, the base ingredients of the plant-based chicken-like meat include water (such as about 50-75% or about 55-67% w/w of concentration at the final formula of the plant-based chicken-like substitute); sunflower oil (such as about 10-15% or about 11-13% w/w of concentration at the final formula of the plant-based chicken-like substitute); pea, chickpea and broad bean proteins (such as about 10-20% or about 14-17% w/w of concentration at the final formula of the plant-based chicken-like substitute); methylcellulose (such as about 1-5% or 2.5-3.0% w/w of concentration at the final formula of the plant-based chicken-like substitute); gluten (such as about 1-5% or 2.0-3.0% w/w of concentration at the final formula of the plant-based chicken-like substitute); bamboo and wheat fibers (such as about 1-5% or 3.0-3.5% w/w of concentration at the final formula of the plant-based chicken-like substitute); and sodium chloride (such as 0.1-1.0% or 0.6-0.8% w/w of concentration at the final formula of the plant-based chicken-like substitute).

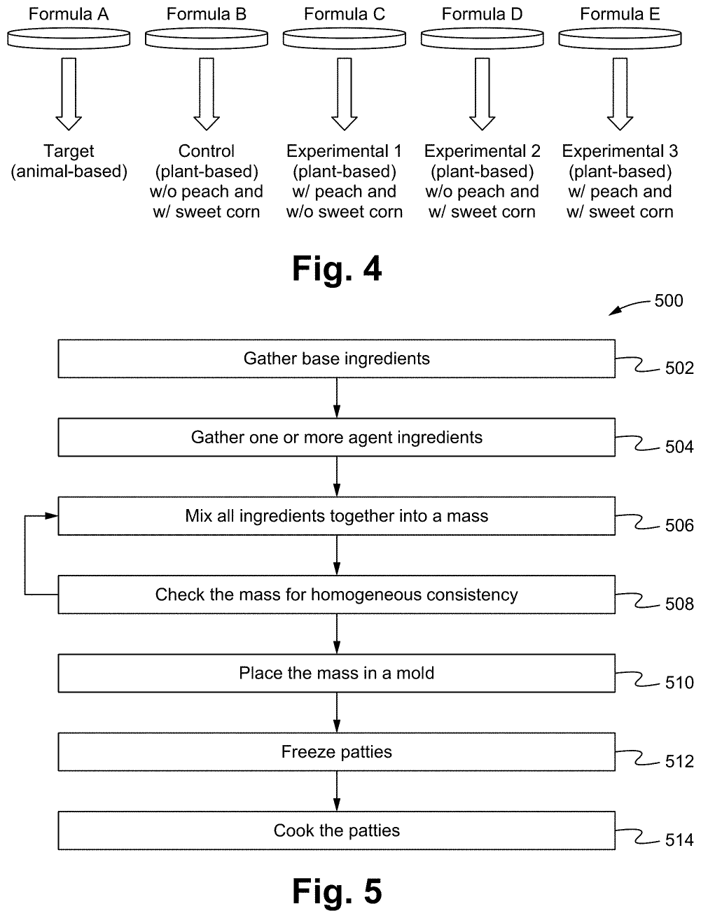

FIG. 4 illustrates an experimental design for trained sensorial panel evaluations. Four plant-based chicken-like substitute groups were tested and evaluated against the animal-based target. Formula A is the animal-based target (cooked chicken). Formula B pertains to a group of the plant-based chicken-like substitute samples (control samples) that did not include a Prunus persica component and a Zea mays component. Formula C pertains to a group of plant-based chicken-like substitute samples (first experimental samples) that included a Prunus persica component but not a Zea mays component. Formula D pertains to a group of plant-based chicken-like substitute samples (second experimental samples) that included a Zea mays component but not a Prunus persica component. Formula E pertains to a group of plant-based chicken-like substitute samples (third experimental samples) that included a Prunus persica component and a Zea mays component.

FIG. 5 illustrates an example method 500 of preparing a plant-based chicken-like substitute in accordance with some embodiments. Method 500 was implemented according to the experimental design of FIG. 4. The method 500 was repeated multiple times to prepare the samples from different groups (e.g., Formulas B, C, E, and E) for sensory analysis.

In FIG. 5, at Step 502, the base ingredients of the plant-based chicken-like meat are gathered according to a combination of the weights described above for the base ingredients. The base ingredients, when combined and mixed into a dough, mimic a texture and color of chicken.

At optional Step 504, one or more ingredients of the plant-based chicken flavoring agent are gathered, depending on the group of samples being prepared. For example, for the control samples, Step 504 is skipped; for the first experimental samples, only the Prunus persica extract is gathered; for the second experimental sample, only the Zea mays extract is gathered; and, for the third experimental sample, the Prunus persica extract and Zea mays extract are both gathered. In an embodiment, the extracts may be freeze dried extracts prepared according to method 200 or another suitable method. In an embodiment, the one or more ingredients may be gathered according to method 300 or another suitable method.

In an embodiment, the chicken-like flavoring agent is prepared in different Prunus persica extract to Zea mays extract proportions, such as about 1:1, 1:2, 1:4, 2:1, 4:1, among others, at about 0.0015-0.030% w/w of concentration at the final formula of the plant-based chicken-like substitute. In an embodiment, the concentration of the flavoring agent is about 0.003-0.018% w/w of concentration at the final formula of the plant-based chicken-like substitute. The concentration of the flavoring agent depends on the proportion of the Prunus persica extract to the Zea mays extract.

In an embodiment, the concentration of the Prunus persica extract is between 0.001-0.006% w/w of the concentration at the final formula of the plant-based chicken-like substitute, and the concentration of the Zea mays extract is between 0.002-0.012% w/w of the concentration at the final formula of the plant-based chicken-like substitute. In an embodiment, the concentration of the Prunus persica extract is between 0.001-0.004% w/w of the concentration at the final formula of the plant-based chicken-like substitute, and the concentration of the Zea mays extract is between 0.002-0.008% w/w of the concentration at the final formula of the plant-based chicken-like substitute.

At Step 506, all ingredients for the plant-based chicken-like meat from Step 502 and all ingredients for the plant-based chicken flavoring agent from optional Step 504, if any, are mixed together such as by a mixer to form a mass of the plant-based chicken-like substitute. At Step 508, the mass is checked for homogeneity. If the mass does not have a homogeneous consistency, then Step 506 is repeated.

Once the mass has a homogeneous consistency, then at Step 510, the mass is placed in a mold, such as a patty mold.

At Step 512, the plant-based chicken-like substitute patties are chilled at −18° C. (±3° C.) for at least 24 hours (±5 hours).

At Step 514, the patties are cooked in a frying pan at 180° C. (±10° C.), approximately five minutes per side.

After samples were prepared according to the method 500, the patties were tasted and evaluated by the trained panel. The trained panel included at least one person to taste the cooked food item(s) resulting from Step 514 and to provide feedback. The feedback included feedback on sensorial descriptors (e.g., color, smell, flavor, taste, mouthfeel, etc.) as well as visual appearances. In some instances, the feedback provided by the feedback panel included feedback based on a modified formula.

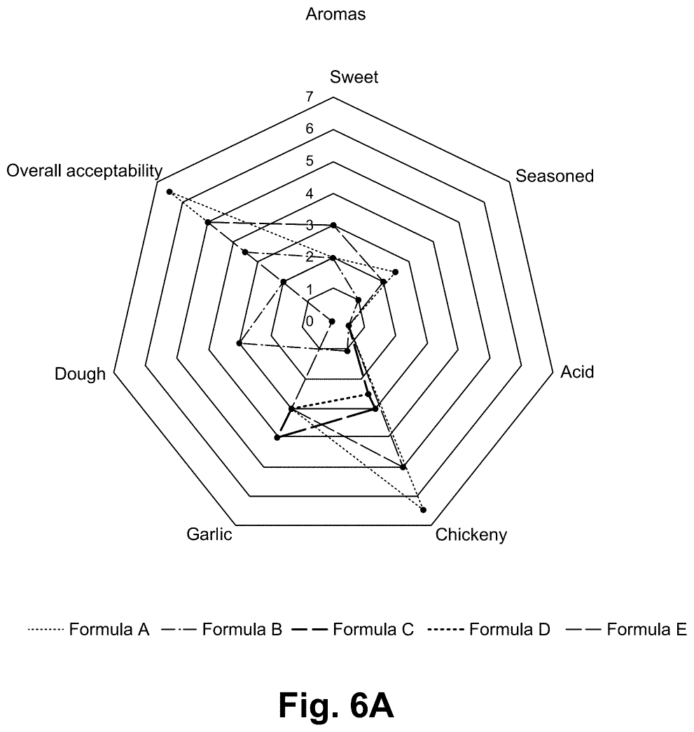

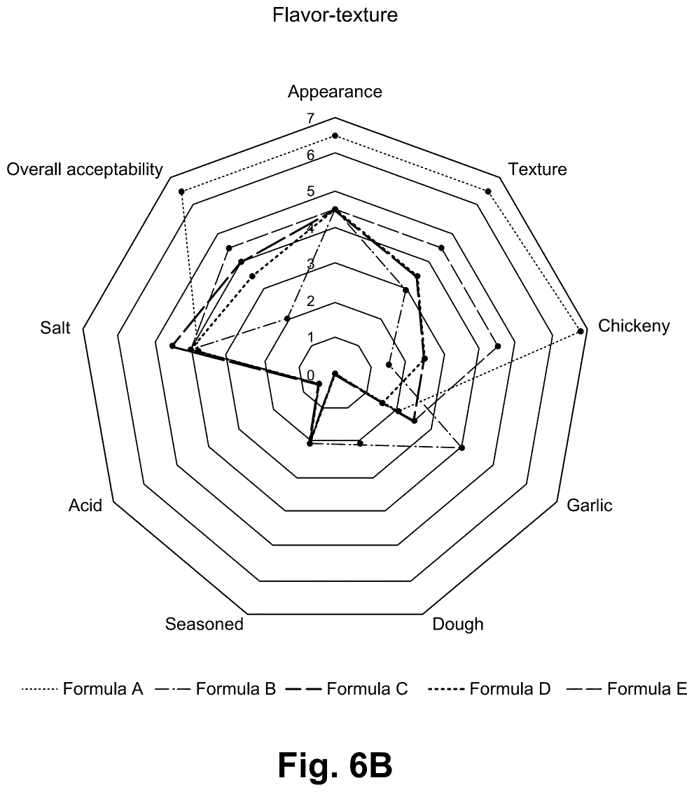

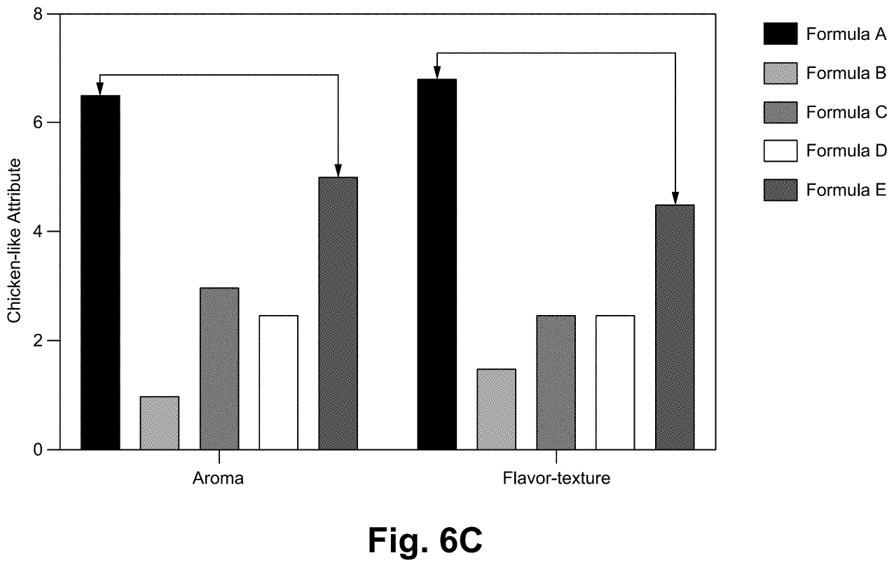

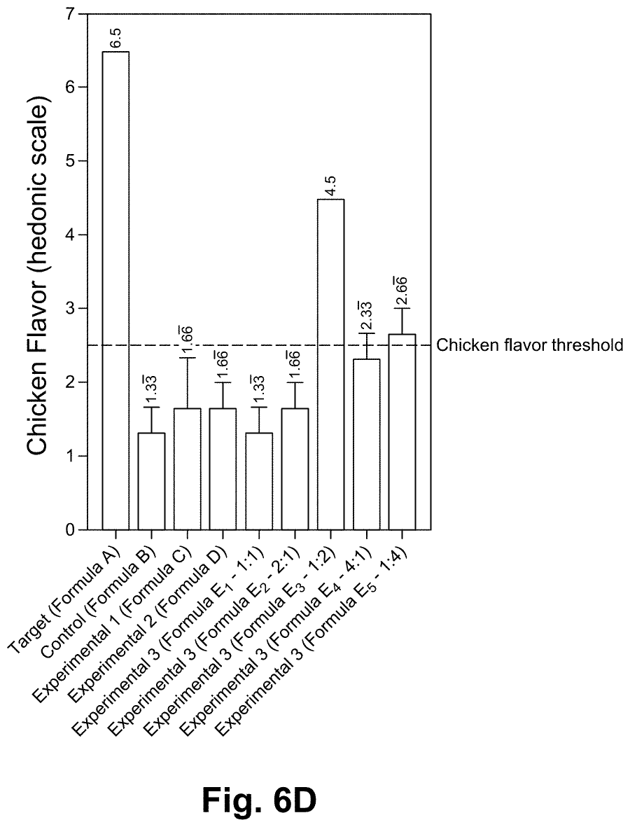

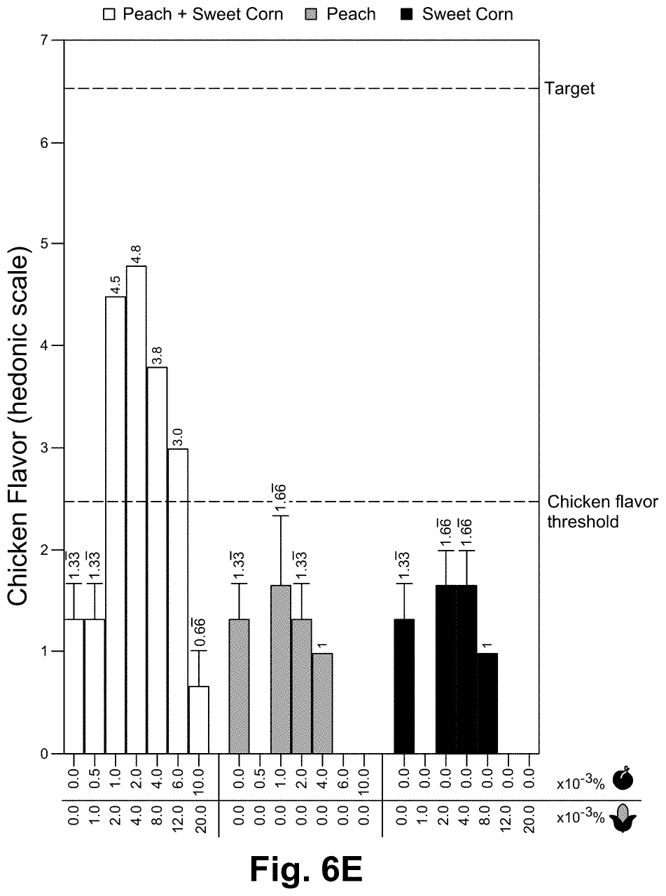

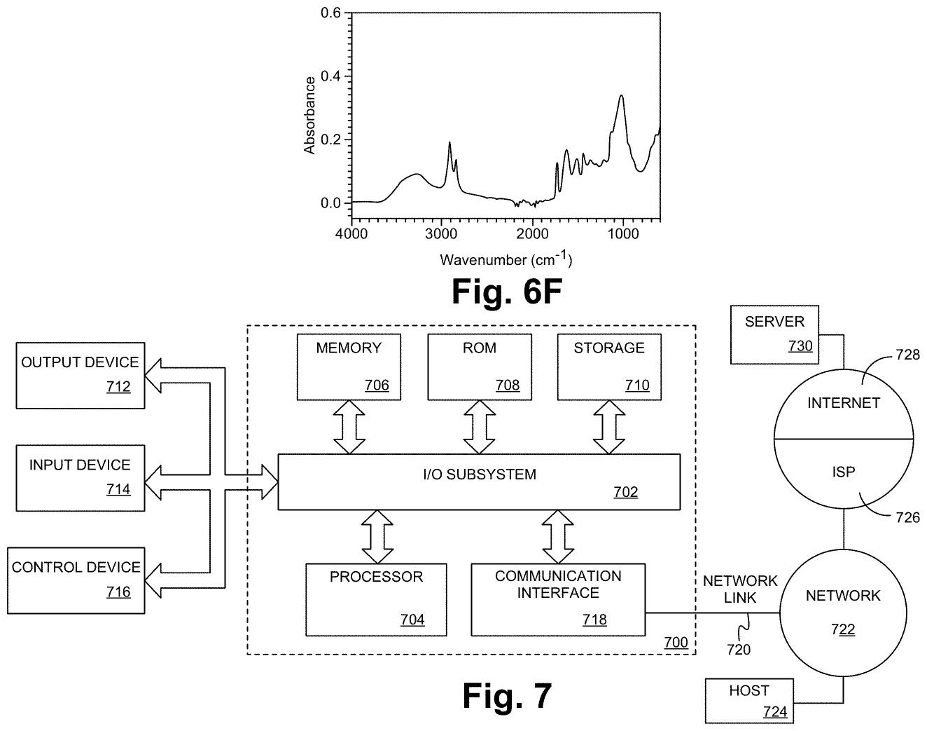

FIGS. 6A-6E illustrate results of a sensory analysis of the animal-based target (cooked chicken) and the four groups of samples. It was observed that addition of a Prunus persica component, a Zea mays component, together and separately, have a masking effect on the base doughy flavor of plant-based chicken-like meat.

FIG. 6A illustrates a sensorial spider web graph of aroma perceptions, as evaluated by the trained panel, of 1:2 (a Prunus persica component to a Zea mays component) proportion. The animal-based target (cooked chicken) and the four groupings of samples were evaluated against sweet, seasoned, acid, chickeny, garlic, and dough aromas, and against overall acceptability. As illustrated in FIG. 6A, Formula E best matched Formula A with regards to the aromas and overall acceptability.

FIG. 6B illustrates a sensorial spider web graph of taste perceptions, as evaluated by the trained panel, of 1:2 (a Prunus persica component to a Zea mays component) proportion. The animal-based target (cooked chicken) and the four groups of samples were evaluated against appearance, texture, and seasoned, acid, salt, chickeny, garlic, and dough flavors, and against overall acceptability. As illustrated in FIG. 6B, Formula E best matched Formula A with regards to the appearance, texture, flavor, and overall acceptability.

FIG. 6C illustrates a graph extracted from the trained panel evaluation of aromas (of FIG. 6A) and flavor-textures (of FIG. 6B) of chicken-like attribute. Arrows show that the Formula E is the closest to the animal-based target (Formula A) than the other sample formulas.

FIG. 6D illustrates a graph of an evaluation of samples based on the experimental design of FIG. 4. The samples include those of Formula B (e.g., the control samples), Formula C (e.g., the first experimental samples), Formula D (e.g., the second experimental samples), and Formula E (e.g., the third experimental samples). Five variations of Formula E, each with different proportions of the Prunus persica component to the Zea mays component as applied to plant-based chicken-like meat, were evaluated. The chicken flavoring threshold is 2.5 on a hedonic scale of 0 to 9. In other words, the threshold of 2.5 is when chicken flavor is evident in the plant-based chicken-like substitutes. The 7-point hedonic scale is anchored by one end of the spectrum with 0=“absolutely no chicken flavor” and 9=“chicken flavor”.

The plant-based chicken flavoring agents associated with Formula E include plant-based chicken flavoring agents having a ratio of 1:1 of the Prunus persica component to the Zea mays component (Formula E₁), a ratio of 2:1 of the Prunus persica component to the Zea mays component (Formula E₂), a ratio of 1:2 of the Prunus persica component to the Zea mays component (Formula E₃), a ratio of 4:1 of the Prunus persica component to the Zea mays component (Formula E₄), and a ratio of 1:4 of the Prunus persica component to the Zea mays component (Formula E₅).

As shown in the graph of FIG. 6D, Formula B and Formula E₁ correspond to approximately 1.3 on the hedonic scale; Formula C, Formula D, and Formula E₂ correspond to approximately 1.7 on the hedonic scale; Formula E₄ corresponds to approximately 2.3 on the hedonic scale; Formula E₃ corresponds to approximately 4.5 on the hedonic scale; and, Formula E₅ corresponds to approximately 2.7 on the hedonic scale. The animal-based target corresponds to approximately 6.5 on the hedonic scale. While both Formula E₃ and E₅ exceed the chicken flavor threshold, Formula E₃ provides the best effect of chicken-like flavoring compared to flavoring agents having different ratios of the Prunus persica component to the Zea mays component.

FIG. 6E illustrates a graph of an evaluation of plant-based chicken flavoring agents of various concentrations of the Prunus persica component and the Zea mays component in the proportion of 1:2 and separately as applied to plant-based chicken-like meat. The scale used in FIG. 6E is the same as the scale used in FIG. 6D.

The graph of FIG. 6E shows the results of various concentrations of the flavoring agent associated with the ratio of 1:2 of the Prunus persica component to the Zea mays component. A first concentration of the Prunus persica component is 0.0×10⁻³% w/w of concentration at the final formula of the plant-based chicken-like substitute; a second concentration of the Prunus persica component is 0.5×10⁻³% w/w of concentration at the final formula of the plant-based chicken-like substitute; a third concentration of the Prunus persica component is 1.0×10⁻³% w/w of concentration at the final formula of the plant-based chicken-like substitute; a fourth concentration of the Prunus persica component is 2.0×10⁻³% w/w of concentration at the final formula of the plant-based chicken-like substitute; a fifth concentration of the Prunus persica component is 4.0×10⁻³% w/w of concentration at the final formula of the plant-based chicken-like substitute; a sixth concentration of the Prunus persica component is 6.0×10⁻³% w/w of concentration at the final formula of the plant-based chicken-like substitute; and, a seventh concentration of the Prunus persica component is 10.0×10⁻³% w/w of concentration at the final formula of the plant-based chicken-like substitute. Corresponding concentrations of the Zea mays component in flavoring agents are that double of the Prunus persica component in the flavoring agents, maintaining the 1:2 ratio. The evaluation of flavoring agents including the 1:2 ratio of the Prunus persica component to the Zea mays component is shown in white bars (left of the graph); the evaluation of flavoring agents with just the Prunus persica component is shown in light gray bars (middle of the graph); the evaluation of flavoring agents with just the Zea mays component is shown in dark gray bars (right of the graph).

Referring to the evaluation of the flavoring agents including the 1:2 ratio of the Prunus persica component to the Zea mays component is shown in white bars (left of the graph), flavoring agents associated with the first concentration and second concentration of the Prunus persica component correspond to approximately 1.3 on the hedonic scale; flavoring agent associated with the third concentration of the Prunus persica component corresponds to approximately 4.5 on the hedonic scale; flavoring agent associated with the fourth concentration of the Prunus persica component corresponds to approximately 4.8 on the hedonic scale; flavoring agent associated with the fifth concentration of the Prunus persica component corresponds to approximately 3.8 on the hedonic scale; flavoring agent associated with the sixth concentration of the Prunus persica component corresponds to approximately 3.0 on the hedonic scale; and, flavoring agent associated with the seventh concentration of the Prunus persica component corresponds to approximately 0.6 on the hedonic scale. The results show that % w/w within the range of 0.001% and 0.006% for the Prunus persica component and % w/w within the range of 0.002% and 0.012% for the Zea mays component generate the effect of chicken-like flavoring enhancement but not when separated (see and compare with the light gray and dark gray bars of the graph).

### 4.0 ARTIFICIAL INTELLIGENCE AND MACHINE LEARNING

In an embodiment, the chicken-like flavoring agent, the chicken-like meat, and/or the chicken-like substitute can be derived from a plant-based chicken-like substitute composition recipe (e.g., including an ingredient formula and/or a cooking process, etc.) determined using artificial intelligence (e.g., machine learning, etc.).

For example, the plant-based chicken-like substitute composition can be derived from a plant-based chicken-like substitute composition recipe determined using one or more variants (embodiments, variations, examples, specific examples, etc.), approaches, and/or approaches analogous to that described in U.S. application Ser. No. 17/479,770, filed Sep. 20, 2021, U.S. application Ser. No. 17/479,708, filed Sep. 20, 2021, and U.S. application Ser. No. 17/317,780, filed May 11, 2021, the entire contents of which are hereby incorporated by reference for all purposes as if fully set forth herein.

In a specific example, the plant-based chicken-like substitute composition is derived from a plant-based chicken-like substitute composition recipe determined based on a first artificial intelligence model. In a specific example, the plant-based chicken-like substitute composition recipe can include a formula determined based on the first artificial intelligence model, such as where the formula can include descriptions to combine potential candidates from a plurality of plant-based ingredients in specific proportions, such as based on matching of data features for each of the plurality of plant-based ingredients to data features associated with an animal-based food (e.g., cooked chicken).

In a specific example, the plant-based chicken-like substitute composition recipe can include a cooking process for the formula, such as where the cooking process is determined based on a second artificial intelligence model, and such as where the second artificial intelligence model is trained based on a set of existing recipes. In a specific example, the second artificial intelligence model used in determining the cooking process can include a neural network-based architecture, an autoregressive-based architecture, etc. In a specific example, the second artificial intelligence model is trained based on a set of existing recipes.

For example, the chicken-like flavoring agent can be determined using one or more variants (embodiments, variations, examples, specific examples, etc.), approaches, and/or approaches analogous to that described in U.S. application Ser. No. 17/713,390, filed Apr. 5, 2022, and U.S. application Ser. No. 17/720,684, filed Apr. 14, 2022, the entire contents of which are hereby incorporated by reference for all purposes as if fully set forth herein.

In a specific example, the chicken-like flavoring agent is determined by an artificial intelligence model that includes a graph model, a word model, and a projection model. The graph model generates compound graph embeddings for chemical compounds that are input to the artificial intelligence model. The word model generates flavor word embeddings for flavor profiles that are input to the artificial intelligence model. The projection model includes a compound projector and a flavor projector. The projection model generates a source compound projected embedding of and source flavor projected embeddings (positive and negative) for each source chemical compound by projecting a source compound graph embedding of and source flavor word embeddings (positive and negative) for each source chemical compound into the same space. During training, a loss function of the projection model is minimized such that the source compound projected embedding of a source chemical compound is aligned with its positive source flavor projected embedding but apart from its negative source flavor projected embeddings. After training, the artificial intelligence model is applied to and for at least each source chemical compound to generate source compound projected embeddings and flavor embeddings for desired flavor profiles that can be used to query for chemical compounds.

A computer model suggests candidate sets of source ingredients for food items that are input to the computer model. The computer model is based on solving a linear programming problem to determine a candidate set of one or more source ingredients for a target food item, in which the target food item is presented as a mixed integer programming optimization problem to be solved by the computer model. Using a matrix of chemical compound source ingredient vectors of all source ingredients, the computer model determines the candidate set of source ingredients and their corresponding quantities (amounts). The candidate ingredient set is the most optimal ingredient set for the target food item as a volatile profile for that ingredient set most closely resembles the target food item's volatile profile as compared to other ingredient sets. Objectives of the model include maximizing profile similarity between the target food item and the candidate ingredient set and minimizing profile similarity between the source ingredients in the candidate ingredient set.

In some embodiments, machine learning models and/or other suitable models, suitable components of embodiments, and/or suitable portions of embodiments described herein can include, apply, employ, perform, use, be based on, and/or otherwise be associated with artificial intelligence approaches (e.g., machine learning approaches, etc.) including any one or more of: supervised learning (e.g., using gradient boosting trees, using logistic regression, using back propagation neural networks, using random forests, decision trees, etc.), unsupervised learning (e.g., using an Apriori algorithm, using K-means clustering), semi-supervised learning, a deep learning algorithm (e.g., neural networks, a restricted Boltzmann machine, a deep belief network method, a convolutional neural network method, a recurrent neural network method, stacked auto-encoder method, etc.), reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminant analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable artificial intelligence approach.

However, embodiments of the chicken-like flavoring agent, the chicken-like meat, and/or the chicken-like substitute can be derived from any suitable recipes and/or other suitable outputs determined using artificial intelligence (e.g., machine learning, etc.) and/or other suitable computational approaches.

### 5.0 CHEMICAL ANALYSIS

Chemical analysis of Prunus persica extract and Zea mays extract reveals presence of metabolites that possibly contribute to chicken flavor.

Table 5 shows metabolite composition in the soluble phase in 1:2 proportions of Prunus persica extract to Zea mays extract determined by liquid chromatography-mass spectrometry.

TABLE 5

| | | | % |
|---|---|---|---|
| # | Compound | Source(s) | Abundance |
| 1 | (+) Naringenin | Peach | 0.091 |
| 2 | (+)-dihydrokaempferol | Peach | 0.123 |
| 3 | (2-{[(2R)-2,3-bis[(9Z)-octadec-9-enoyloxy]propyl | Sweet corn | 0.050 |
| | phosphono]oxy}ethyl)trimethylazanium | | |
| 4 | (2-{[3-(hexadecanoyloxy)-2-hydroxypropyl | Peach + | 0.497 |
| | phosphonato]oxy}ethyl)trimethylazanium | Sweet Corn | |
| 5 | (22R)-2β,3β,14,20-tetrahydroxy-22,26-epoxy-5β- | Sweet corn | 0.299 |
| | stigmasta-7,24-diene-6,12,26-trione | | |
| 6 | (Z)-5,8,11-trihydroxyoctadec-9-enoic acid | Peach + | 0.134 |
| | | Sweet Corn | |
| 7 | [2-hydroxy-3-[hydroxy-[2,3,4,5,6- | Peach | 0.023 |
| | pentahydroxycyclohexyl]oxyphosphoryl]oxypropyl] | | |
| | octadecanoate | | |
| 8 | 1-(2E,4E-octadecadienoyl)-sn-glycero-3- | Sweet corn | 1.535 |
| | phosphocholine | | |
| 9 | 1-(5Z,8Z,11Z,14Z-eicosatetraenoyl)-2- | Sweet corn | 0.055 |
| | (5Z,8Z,11Z,14Z,17Z-eicosapentaenoyl)-sn-glycerol | | |
| 10 | 1-(6Z,9Z,12Z-octadecatrienoyl)-glycero-3- | Peach + | 0.458 |
| | phosphocholine | Sweet Corn | |
| 11 | 1-(8-[5]-ladderane-octanoyl)-2-(8-[3]-ladderane- | Peach | 0.017 |
| | octanyl)-sn-glycerophosphocholine | | |
| 12 | 1-(9E-hexadecenoyl)-sn-glycero-3-phosphocholine | Peach + | 0.056 |
| | | Sweet Corn | |
| 13 | 1-(9Z,12Z-octadecadienoyl)-glycero-3- | Peach + | 3.782 |
| | phosphoethanolamine | Sweet Corn | |
| 14 | 1-(9Z,12Z,15Z-octadecatrienoyl)-glycero-3- | Peach | 0.059 |
| | phosphoethanolamine | | |
| 15 | 1-hydroxy-2-stearoyl-sn-glycero-3- | Peach | 0.028 |
| | phosphoethanolamine | | |
| 16 | 1-linoleoyl-phosphatidylcholine | Peach | 1.560 |
| 17 | 1-Linoleoyl-sn-glycero-3-phosphorylcholine | Sweet corn | 6.911 |
| 18 | 1-Methylhistidine | Peach | 0.023 |
| 19 | 1-Oleoyl-2-hydroxy-sn-glycero-3-phosphocholine | Peach + | 0.087 |
| | | Sweet Corn | |
| 20 | 1-palmitoyl-2-hydroxy-sn-glycero-3- | Peach + | 0.484 |
| | phosphoethanolamine | Sweet Corn | |
| 21 | 1-Palmitoyl-2-oleoyl-lecithin | Peach + | 0.110 |
| | | Sweet Corn | |
| 22 | 10,13-Octadecadienoic acid | Sweet corn | 0.089 |
| 23 | 10E,12Z-octadecadienoic acid | Sweet corn | 0.127 |
| 24 | 2-(11Z-octadecenoyl)-sn-glycero-3- | Peach + | 0.070 |
| | phosphoethanolamine | Sweet Corn | |
| 25 | 2-(6Z-octadecenoyl)-sn-glycero-3-phosphocholine | Peach + | 0.339 |
| | | Sweet Corn | |
| 26 | 2-(6Z,9Z,12Z-octadecatrienoyl)-sn-glycero-3- | Sweet corn | 0.021 |
| | phosphoethanolamine | | |
| 27 | 2-(9E-octadecenoyl)-sn-glycero-3-phosphocholine | Sweet corn | 1.720 |
| 28 | 2-(9Z,12Z-octadecadienoyl)-sn-glycero-3- | Sweet corn | 0.468 |
| | phosphoethanolamine | | |
| 29 | 2-hexadecanoyl-sn-glycero-3-phosphoethanolamine | Peach + | 0.952 |
| | | Sweet Corn | |
| 30 | 2-Ketobutyric acid | Peach | 0.025 |
| 31 | 2-octadecanoyl-sn-glycero-3-phosphocholine | Sweet corn | 0.066 |
| 32 | 2-Palmitoyl-sn-glycero-3-phosphocholine | Peach + | 4.038 |
| | | Sweet Corn | |
| 33 | 3-Hydroxyanthranilic acid | Sweet corn | 0.054 |
| 34 | 5-(stearoyloxy)stearic acid | Peach | 0.056 |
| 35 | 5-Dehydro-avenasterol | Sweet corn | 0.222 |
| 36 | 9-hydroxy-10,12-octadecadienoic acid | Peach + | 3.601 |
| | | Sweet Corn | |
| 37 | 9-hydroxy-10E,12Z-octadecadienoic acid | Peach | 0.125 |
| 38 | 9S-hydroperoxy-10E,12Z-octadecadienoic acid | Peach + | 0.121 |
| | | Sweet Corn | |
| 39 | a-fucose | Peach | 0.284 |
| 40 | a-Galactose 1-phosphate | Sweet corn | 0.208 |
| 41 | a-rhamnose | Peach | 0.361 |
| 42 | a-tocopherol | Sweet corn | 0.091 |
| 43 | a-xylose | Peach | 0.326 |
| 44 | a-Linolenic acid | Peach | 0.064 |
| 45 | Adenosine | Peach + | 0.557 |
| | | Sweet Corn | |
| 46 | Alanine | Peach | 0.074 |
| 47 | Allantoic acid | Sweet corn | 0.086 |
| 48 | Apigenin 7-O-glucoside | Peach | 0.075 |
| 49 | Asparagine | Sweet corn | 0.065 |
| 50 | Aspartate | Peach | 0.097 |
| 51 | Astragalin | Peach | 0.059 |
| 52 | b-fucose | Peach | 0.288 |
| 53 | b-rhamnose | Peach | 0.300 |
| 54 | b-xylose | Peach | 0.422 |
| 55 | beta-tocotrienol | Sweet corn | 0.411 |
| 56 | Biotin | Peach | 0.052 |
| 57 | Butyric acid | Peach | 0.005 |
| 58 | Caffeic acid 3-glucoside | Peach | 0.192 |
| 59 | Catechin | Peach | 0.134 |
| 60 | Catechin 7-O-a-L-rhamnopyranoisde | Peach | 0.063 |
| 61 | Chlorogenic acid | Peach | 0.251 |
| 62 | Chrysoeriol 8-C-hexoside | Sweet corn | 0.094 |
| 63 | Chrysoeriol C-hexosyl-O-rhamnoside | Sweet corn | 0.092 |
| 64 | Citric acid | Peach + | 1.536 |
| | | Sweet Corn | |
| 65 | Cyanidin 3-glucoside | Peach | 0.085 |
| 66 | Cytidine | Peach | 0.033 |
| 67 | D-(+)-Malic acid | Peach + | 4.953 |
| | | Sweet Corn | |
| 68 | D-erythro-Sphingosine C-20 | Peach | 0.079 |
| 69 | Diferuloyl putrescine | Sweet corn | 0.557 |
| 70 | Dihydroquercetin | Peach | 0.136 |
| 71 | Disinapoyl hexoside | Sweet corn | 0.051 |
| 72 | Fructose | Peach | 0.660 |
| 73 | Fumarate | Peach + | 0.177 |
| | | Sweet Corn | |
| 74 | g-glutamylcysteine | Sweet corn | 0.082 |
| 75 | g-tocopherol | Sweet corn | 0.173 |
| 76 | Galactarate | Sweet corn | 0.189 |
| 77 | Galactinol | Sweet corn | 0.095 |
| 78 | Galactose | Peach | 0.158 |
| 79 | Geniposide | Peach | 0.056 |
| 80 | Gentiobiose | Sweet corn | 1.699 |
| 81 | Glucose | Peach | 0.705 |
| 82 | Glutamate | Sweet corn | 0.079 |
| 83 | Glutamine | Sweet corn | 0.089 |
| 84 | Heptadecasphinganine-1-phosphate | Peach + | 3.018 |
| | | Sweet Corn | |
| 85 | Hexosyl LPE 16:0 | Sweet corn | 0.111 |
| 86 | Hexosyl LPE 18:2 | Peach | 0.071 |
| 87 | Hyperin | Peach | 0.061 |
| 88 | Inositol | Peach | 0.274 |
| 89 | Isoleucine | Peach | 0.061 |
| 90 | Kaempferol 4′-glucoside | Peach | 0.083 |
| 91 | L-asparagine | Peach + | 0.141 |
| | | Sweet Corn | |
| 92 | L-Tyrosine | Sweet corn | 0.211 |
| 93 | Lauryldiethanolamine | Peach + | 0.098 |
| | | Sweet Corn | |
| 94 | Leucopelargonidin | Peach | 0.076 |
| 95 | Linoleic acid | Peach | 1.522 |
| 96 | Luteoloside | Peach | 0.066 |
| 97 | Malate | Peach + | 0.707 |
| | | Sweet Corn | |
| 98 | N-Feruloyl putrescine | Sweet corn | 0.101 |
| 99 | N-Fructosyl isoleucine | Peach + | 0.693 |
| | | Sweet Corn | |
| 100 | N-Fructosyl phenylalanine | Peach + | 0.227 |
| | | Sweet Corn | |
| 101 | N-Heptanoylsolamine | Peach | 0.054 |
| 102 | N′,N″-Diferuloylspermidine | Sweet corn | 0.135 |
| 103 | Octadec-17-en-7-ynoic acid | Sweet corn | 0.061 |
| 104 | Ononin | Peach | 0.080 |
| 105 | Pelargonidin 3-glucoside | Peach | 0.087 |
| 106 | Peonidin 3-[2-(xylosyl)galactoside] | Peach | 0.068 |
| 107 | Phenylalanine | Peach | 0.097 |
| 108 | 3,4-Dihydrocoumarin | Sweet corn | 0.151 |
| 109 | Phloridzin | Peach | 0.081 |
| 110 | Pipecolate | Sweet corn | 0.118 |
| 111 | Proline | Peach + | 0.309 |
| | | Sweet Corn | |
| 112 | Provitamin D6 | Sweet corn | 0.634 |
| 113 | Prunasin | Peach | 0.222 |
| 114 | Quercetin | Peach | 0.117 |
| 115 | Quercetin 3-O-glucoside | Peach | 0.069 |
| 116 | Quinic acid | Peach | 0.537 |
| 117 | Shikimate | Peach | 0.060 |
| 118 | Skimmin | Sweet corn | 0.192 |
| 119 | Sorbitol | Peach | 0.449 |
| 120 | Succinate | Peach | 0.080 |
| 121 | Sucrose | Peach | 0.830 |
| 122 | Syringin | Peach | 0.062 |
| 123 | Trehalose | Peach + | 3.842 |
| | | Sweet Corn | |
| 124 | Tricin | Sweet corn | 0.067 |
| 125 | Tricin 7-diglucuronoside | Sweet corn | 0.112 |
| 126 | Trigonelline | Peach | 0.089 |
| 127 | Tris(1-chloro-2-propyl)phosphate | Sweet corn | 0.492 |
| 128 | UDP-glucose | Sweet corn | 0.116 |
| 129 | Valine | Peach | 0.061 |
| 130 | Vitamin D6 | Sweet corn | 0.078 |
| 131 | Unknown compounds | Peach + | 38.412 |
| | (316 in peach + 482 in sweet corn) | Sweet Corn | |

Table 6 shows chemical structures in soluble phase.

TABLE 6

| # | Chemical Structure |
|---|---|
| 1 | 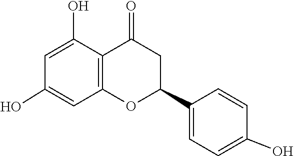 [SMILES: O=C1C[C@@H](c2ccc(O)cc2)Oc2cc(O)cc(O)c21] |

| | |
|---|---|
| 2 | 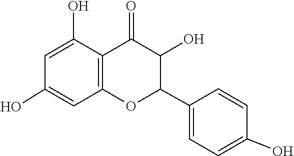 [SMILES: O=C1c2c(O)cc(O)cc2OC(c2ccc(O)cc2)C1O] |
| 3 | 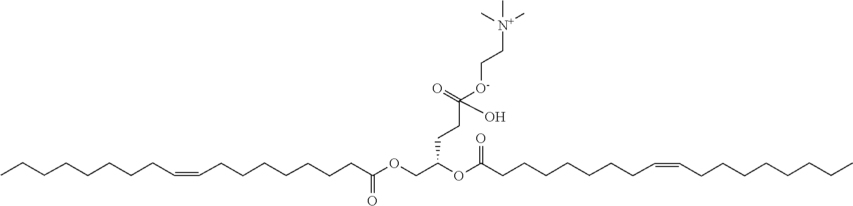 |
| 4 | 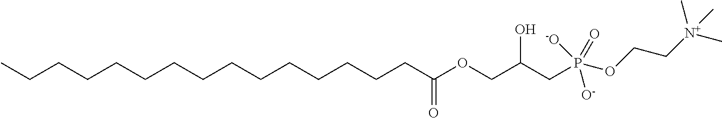 |
| 5 | 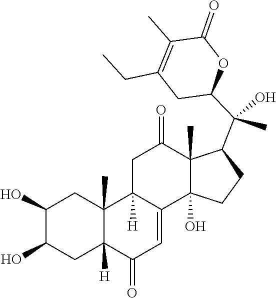 |
| 6 | 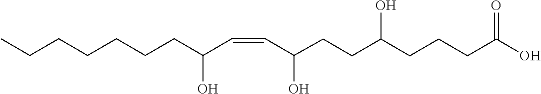 [SMILES: CCCCCCCC(O)/C=C\C(O)CCC(O)CCCC(=O)O] |

| | |
|---|---|
| 7 | 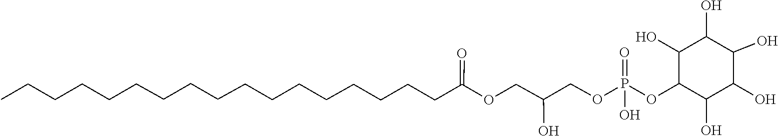 [SMILES: CCCCCCCCCCCCCCCCCC(=O)OCC(O)COP(=O)(O)OC1C(O)C(O)C(O)C(O)C1O] |

| | |
|---|---|
| 8 | 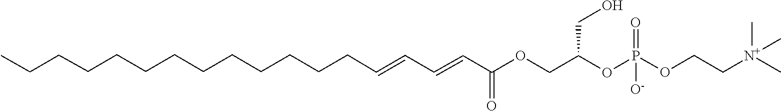 [SMILES: CCCCCCCCCCCCC/C=C/C=C/C(=O)OC[C@H](CO)OP(=O)([O-])OCC[N+](C)(C)C] |

| | |
|---|---|
| 9 | 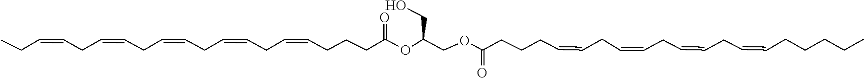 [SMILES: CC/C=C\C/C=C\C/C=C\C/C=C\C/C=C\CCCC(=O)O[C@@H](CO)COC(=O)CCC/C=C\C/C=C\C/C=C\C/C=C\CCCCC] |

| | |
|---|---|
| 10 | 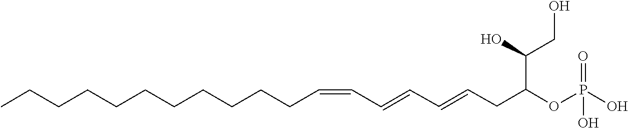 [SMILES: CCCCCCCCCCC\C=C/C=C/C=C/CC(OP(=O)(O)O)[C@@H](O)CO] |

| | |
|---|---|
| 11 | 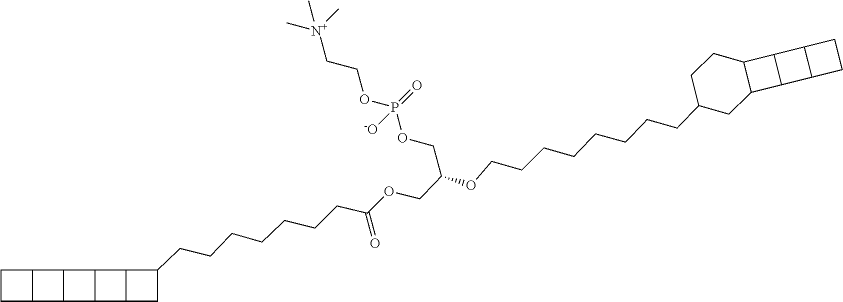 |

| | |
|---|---|
| 12 | 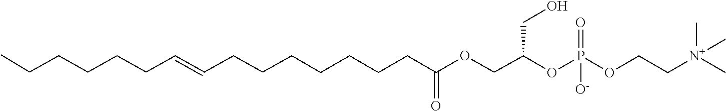 [SMILES: CCCCCC/C=C/CCCCCCCC(=O)OC[C@H](CO)OP(=O)([O-])OCC[N+](C)(C)C] |

| | |
|---|---|
| 13 | 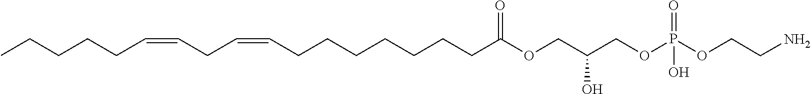 [SMILES: CCCCC/C=C\C/C=C\CCCCCCCC(=O)OC[C@@H](O)COP(=O)(O)OCCN] |

| | |
|---|---|
| 14 | 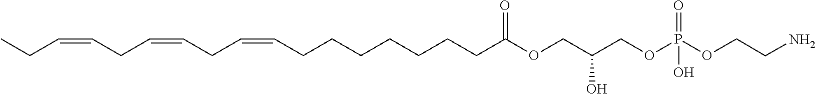 [SMILES: CC/C=C\C/C=C\C/C=C\CCCCCCCC(=O)OC[C@@H](O)COP(=O)(O)OCCN] |

| | |
|---|---|
| 15 | 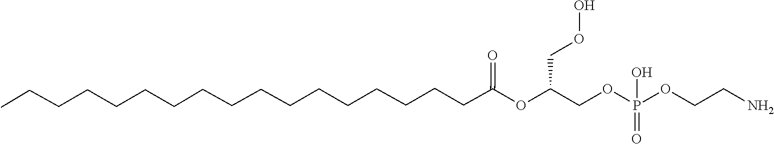 [SMILES: CCCCCCCCCCCCCCCCCC(=O)O[C@H](COO)COP(=O)(O)OCCN] |

| | |
|---|---|
| 16 | 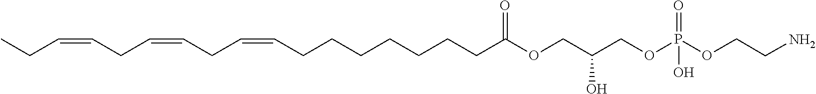 [SMILES: CC/C=C\C/C=C\C/C=C\CCCCCCCC(=O)OC[C@@H](O)COP(=O)(O)OCCN] |

| | |
|---|---|
| 17 | 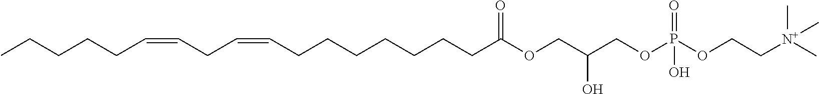 [SMILES: CCCCC/C=C\C/C=C\CCCCCCCC(=O)OCC(O)COP(=O)(O)OCC[N+](C)(C)C] |

| | |
|---|---|
| 18 | 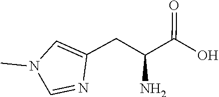 |

| | |
|---|---|
| 19 | 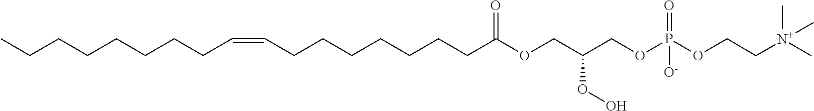 [SMILES: CCCCCCCC/C=C\CCCCCCCC(=O)OC[C@H](COP(=O)([O-])OCC[N+](C)(C)C)OO] |
| 20 | 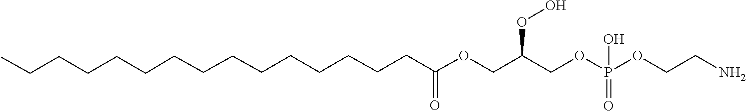 [SMILES: CCCCCCCCCCCCCCCC(=O)OC[C@H](COP(=O)(O)OCCN)OO] |
| 21 | 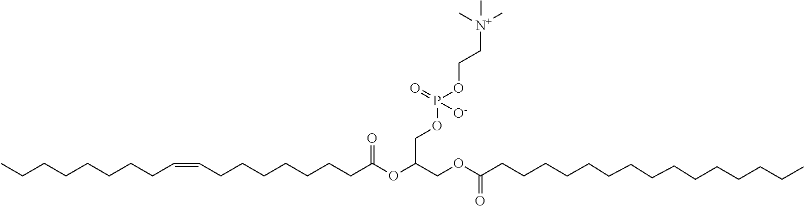 [SMILES: CCCCCCCC/C=C\CCCCCCCC(=O)OC(COC(=O)CCCCCCCCCCCCCCC)COP(=O)([O-])OCC[N+](C)(C)C] |

| | |
|---|---|
| 22 | 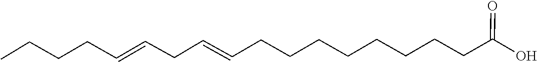 [SMILES: CCCC/C=C/C/C=C/CCCCCCCCC(=O)O] |

| | |
|---|---|
| 23 | 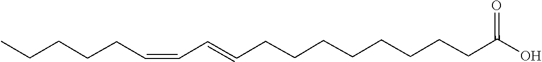 [SMILES: CCCCC/C=C\C=C\CCCCCCCCC(=O)O] |

| | |
|---|---|
| 24 | 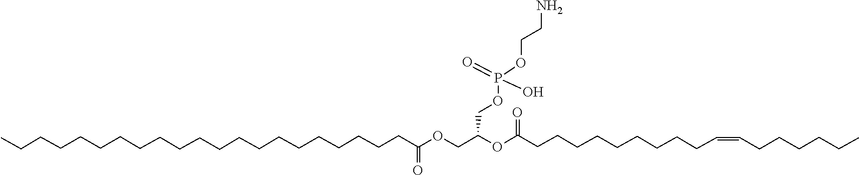 [SMILES: CCCCCC/C=C\CCCCCCCCCC(=O)O[C@H](COC(=O)CCCCCCCCCCCCCCCCCCCCC)COP(=O)(O)OCCN] |
| 25 | 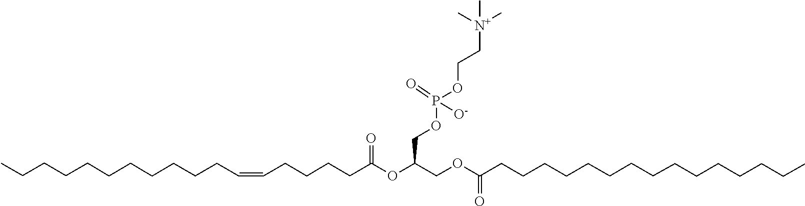 [SMILES: CCCCCCCCCCC/C=C\CCCCC(=O)O[C@H](COC(=O)CCCCCCCCCCCCCCC)COP(=O)([O-])OCC[N+](C)(C)C] |
| 26 | 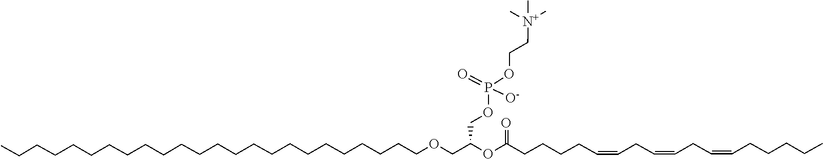 [SMILES: CCCCC/C=C\C/C=C\C/C=C\CCCCC(=O)O[C@H](COCCCCCCCCCCCCCCCCCCCCCCCC)COP(=O)([O-])OCC[N+](C)(C)C] |
| 27 | 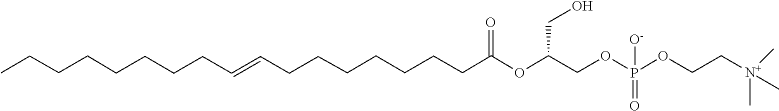 [SMILES: CCCCCCCC/C=C/CCCCCCCC(=O)O[C@H](CO)COP(=O)([O-])OCC[N+](C)(C)C] |

| | |
|---|---|
| 28 | 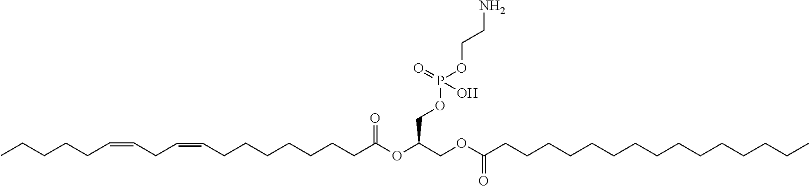 [SMILES: CCCCC/C=C\C/C=C\CCCCCCCC(=O)O[C@H](COC(=O)CCCCCCCCCCCCCCC)COP(=O)(O)OCCN] |

| | |
|---|---|
| 29 | 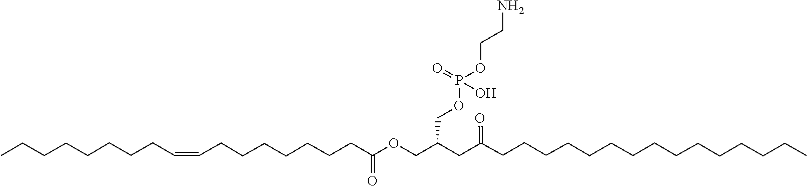 [SMILES: CCCCCCCC/C=C\CCCCCCCC(=O)OC[C@H](COP(=O)(O)OCCN)CC(=O)CCCCCCCCCCCCCCC] |

| | |
|---|---|
| 30 | 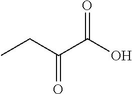 |
| 31 | 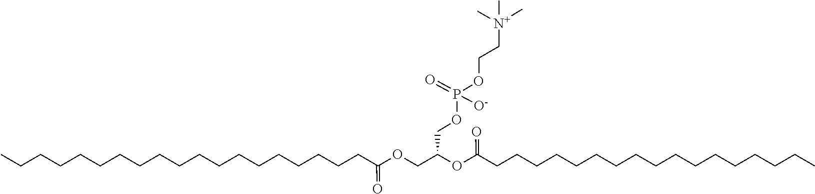 [SMILES: CCCCCCCCCCCCCCCCCCCC(=O)OC[C@H](COP(=O)([O-])OCC[N+](C)(C)C)OC(=O)CCCCCCCCCCCCCCCCC] |
| 32 | 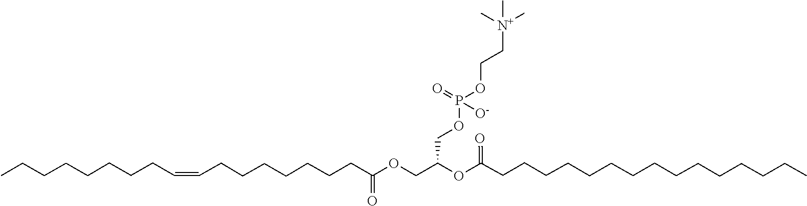 [SMILES: CCCCCCCC/C=C\CCCCCCCC(=O)OC[C@H](COP(=O)([O-])OCC[N+](C)(C)C)OC(=O)CCCCCCCCCCCCCCC] |
| 33 | 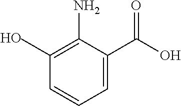 |

| | |
|---|---|
| 34 | 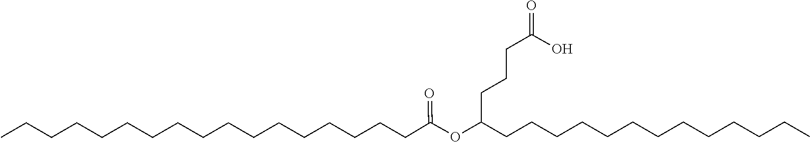 [SMILES: CCCCCCCCCCCCCCCCCC(=O)OC(CCCCCCCCCCCCC)CCCC(=O)O] |

| | |
|---|---|
| 35 | 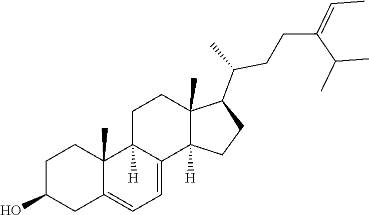 |

| | |
|---|---|
| 36 | 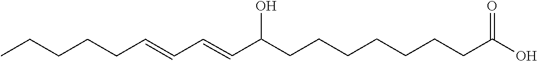 [SMILES: CCCCC/C=C/C=C/C(O)CCCCCCCC(=O)O] |

| | |
|---|---|
| 37 | 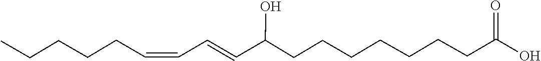 [SMILES: CCCCC/C=C\C=C\C(O)CCCCCCCC(=O)O] |

| | |
|---|---|
| 38 | 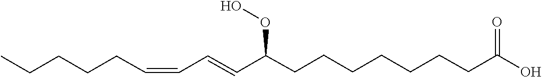 [SMILES: CCCCC/C=C\C=C\[C@H](CCCCCCCC(=O)O)OO] |

| | |
|---|---|
| 39 | 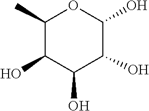 |

| | |
|---|---|
| 40 | 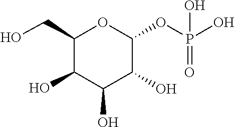 [SMILES: O=P(O)(O)O[C@H]1O[C@H](CO)[C@H](O)[C@H](O)[C@H]1O] |

| | |
|---|---|
| 41 | 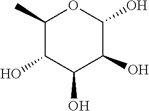 |

| | |
|---|---|
| 42 | 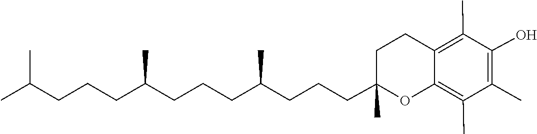 [SMILES: Cc1c(C)c2c(c(C)c1O)CC[C@@](C)(CCC[C@H](C)CCC[C@H](C)CCCC(C)C)O2] |

| | |
|---|---|
| 43 | 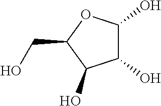 |

| | |
|---|---|
| 44 | 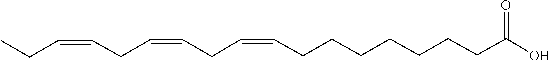 [SMILES: CC/C=C\C/C=C\C/C=C\CCCCCCCC(=O)O] |

| | |
|---|---|
| 45 | 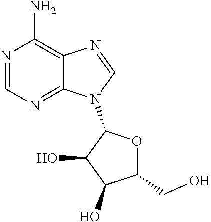 [SMILES: Nc1ncnc2c1ncn2[C@@H]1O[C@H](CO)[C@@H](O)[C@H]1O] |

| | |
|---|---|
| 46 | 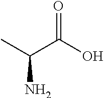 |

| | |
|---|---|
| 47 | 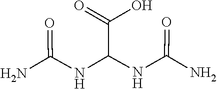 [SMILES: NC(=O)NC(NC(N)=O)C(=O)O] |

| | |
|---|---|
| 48 | 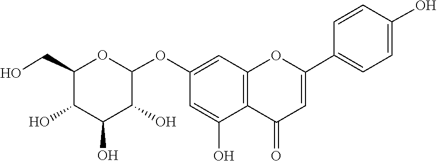 [SMILES: O=c1cc(-c2ccc(O)cc2)oc2cc(OC3O[C@H](CO)[C@@H](O)[C@H](O)[C@H]3O)cc(O)c12] |

| | |
|---|---|
| 49 | 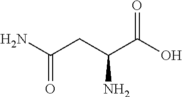 |

| | |
|---|---|
| 50 | 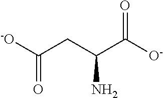 |

| | |
|---|---|
| 51 | 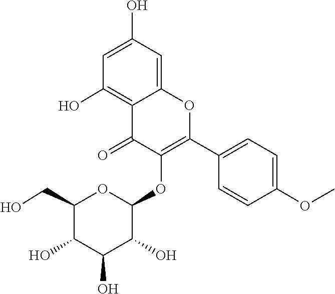 [SMILES: COc1ccc(-c2oc3cc(O)cc(O)c3c(=O)c2O[C@@H]2O[C@H](CO)[C@@H](O)[C@H](O)[C@H]2O)cc1] |

| | |
|---|---|
| 52 | 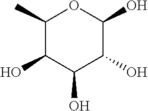 |

| | |
|---|---|
| 53 | 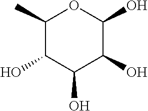 |

| | |
|---|---|
| 54 | 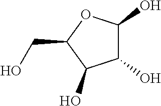 |

| | |
|---|---|
| 55 | 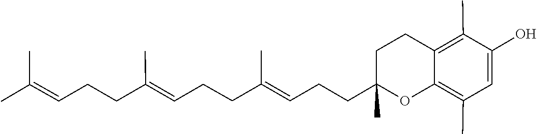 [SMILES: CC(C)=CCC/C(C)=C/CC/C(C)=C/CC[C@]1(C)CCc2c(C)c(O)cc(C)c2O1] |

| | |
|---|---|
| 56 | 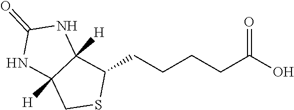 [SMILES: O=C(O)CCCC[C@@H]1SC[C@@H]2NC(=O)N[C@@H]21] |

| | |
|---|---|
| 57 | 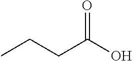 |

| | |
|---|---|
| 58 | 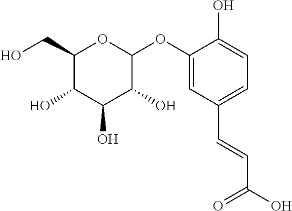 [SMILES: O=C(O)/C=C/c1ccc(O)c(OC2O[C@H](CO)[C@@H](O)[C@H](O)[C@H]2O)c1] |

| | |
|---|---|
| 59 | 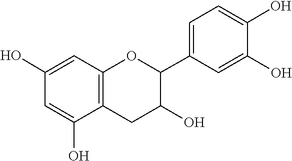 [SMILES: Oc1cc(O)c2c(c1)OC(c1ccc(O)c(O)c1)C(O)C2] |
| 60 | 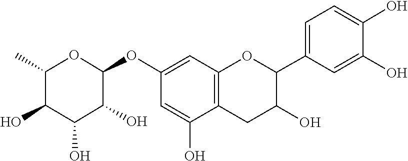 [SMILES: C[C@@H]1O[C@@H](Oc2cc(O)c3c(c2)OC(c2ccc(O)c(O)c2)C(O)C3)[C@H](O)[C@H](O)[C@H]1O] |
| 61 | 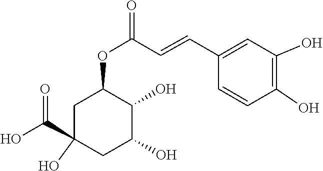 [SMILES: O=C(/C=C/c1ccc(O)c(O)c1)O[C@@H]1C[C@](O)(C(=O)O)C[C@@H](O)[C@H]1O] |

| | |
|---|---|
| 62 | 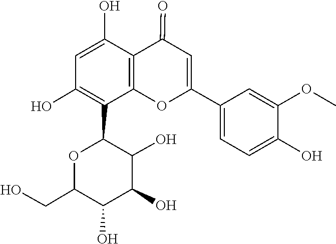 [SMILES: COc1cc(-c2cc(=O)c3c(O)cc(O)c([C@@H]4OC(CO)[C@@H](O)[C@H](O)C4O)c3o2)ccc1O] |

| | |
|---|---|
| 63 | 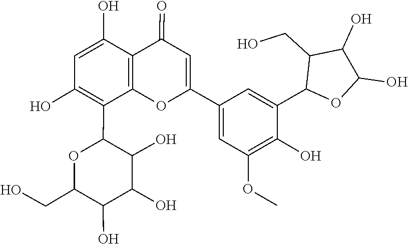 [SMILES: COc1cc(-c2cc(=O)c3c(O)cc(O)c(C4OC(CO)C(O)C(O)C4O)c3o2)cc(C2OC(O)C(O)C2CO)c1O] |

| | |
|---|---|
| 64 | 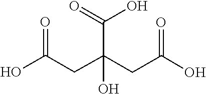 [SMILES: O=C(O)CC(O)(CC(=O)O)C(=O)O] |
| 65 | 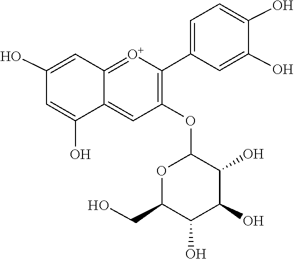 [SMILES: OC[C@H]1OC(Oc2cc3c(O)cc(O)cc3[o+]c2-c2ccc(O)c(O)c2)[C@H](O)[C@@H](O)[C@@H]1O] |
| 66 | 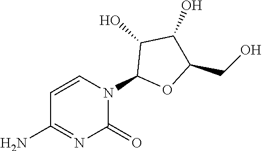 [SMILES: Nc1ccn([C@@H]2O[C@H](CO)[C@@H](O)[C@H]2O)c(=O)n1] |

| | |
|---|---|
| 67 | 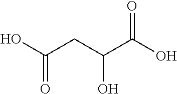 |

| | |
|---|---|
| 68 | 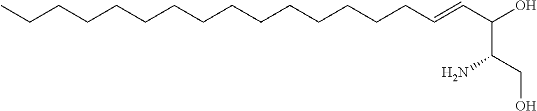 [SMILES: CCCCCCCCCCCCCCC/C=C/C(O)[C@@H](N)CO] |

| | |
|---|---|
| 69 | 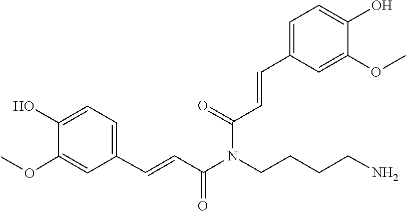 |

| | |
|---|---|
| 70 | 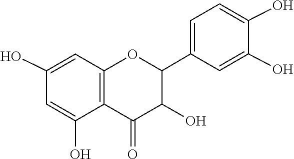 [SMILES: O=C1c2c(O)cc(O)cc2OC(c2ccc(O)c(O)c2)C1O] |

| | |
|---|---|
| 71 | 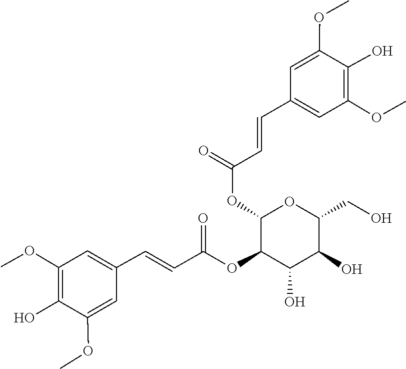 |

| | |
|---|---|
| 72 | 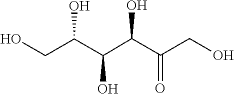 [SMILES: O=C(CO)[C@H](O)[C@@H](O)[C@@H](O)CO] |

| | |
|---|---|
| 73 | 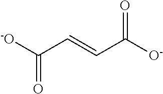 |

| | |
|---|---|
| 74 | 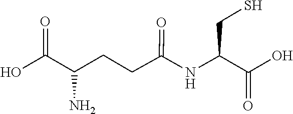 |

| | |
|---|---|
| 75 | 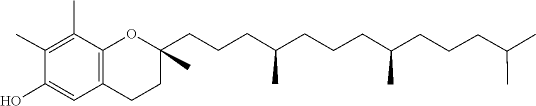 [SMILES: Cc1c(O)cc2c(c1C)O[C@](C)(CCC[C@H](C)CCC[C@H](C)CCCC(C)C)CC2] |

| | |
|---|---|
| 76 | 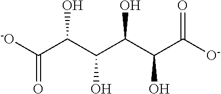 |
| 77 | 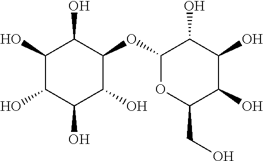 [SMILES: OC[C@H]1O[C@H](O[C@@H]2[C@H](O)[C@H](O)[C@@H](O)[C@H](O)[C@H]2O)[C@H](O)[C@@H](O)[C@H]1O] |
| 78 | 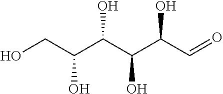 [SMILES: O=C[C@H](O)[C@@H](O)[C@@H](O)[C@H](O)CO] |
| 79 | 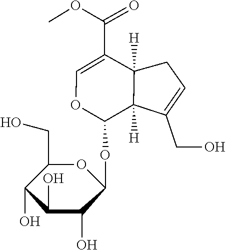 |
| 80 | 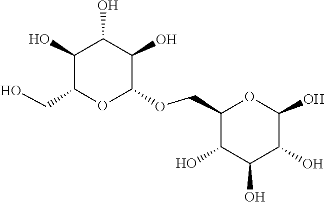 [SMILES: OC[C@H]1O[C@@H](OC[C@H]2O[C@@H](O)[C@H](O)[C@@H](O)[C@@H]2O)[C@H](O)[C@@H](O)[C@@H]1O] |

| | |
|---|---|
| 81 | 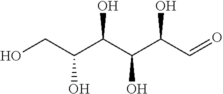 [SMILES: O=C[C@H](O)[C@@H](O)[C@H](O)[C@H](O)CO] |

| | |
|---|---|
| 82 | 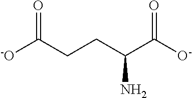 |

| | |
|---|---|
| 83 | 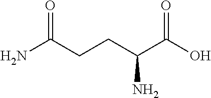 |

| | |
|---|---|
| 84 | 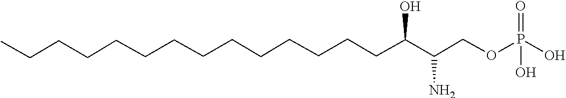 |

| | |
|---|---|
| 85 | 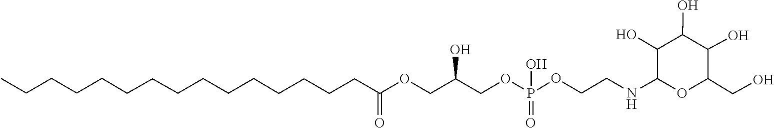 [SMILES: CCCCCCCCCCCCCCCC(=O)OC[C@@H](O)COP(=O)(O)OCCNC1OC(CO)C(O)C(O)C1O] |

| | |
|---|---|
| 86 | 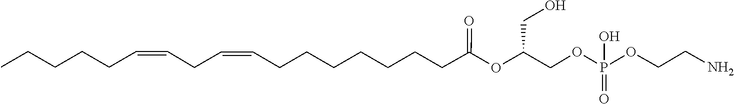 [SMILES: CCCCC/C=C\C/C=C\CCCCCCCC(=O)O[C@H](CO)COP(=O)(O)OCCN] |

| | |
|---|---|
| 87 | 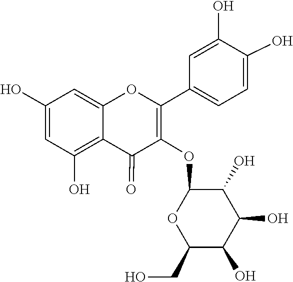 [SMILES: O=c1c(O[C@@H]2O[C@H](CO)[C@H](O)[C@H](O)[C@H]2O)c(-c2ccc(O)c(O)c2)oc2cc(O)cc(O)c12] |

| | |
|---|---|
| 88 | 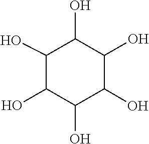 [SMILES: OC1C(O)C(O)C(O)C(O)C1O] |

| | |
|---|---|
| 89 | 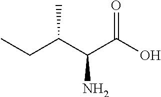 |
| 90 | 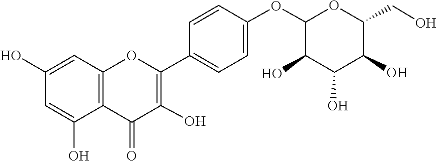 [SMILES: O=c1c(O)c(-c2ccc(OC3O[C@H](CO)[C@@H](O)[C@H](O)[C@H]3O)cc2)oc2cc(O)cc(O)c12] |
| 91 | 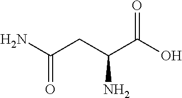 |

| | |
|---|---|
| 92 | 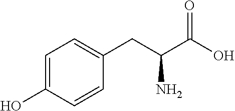 [SMILES: N[C@@H](Cc1ccc(O)cc1)C(=O)O] |

| | |
|---|---|
| 93 | 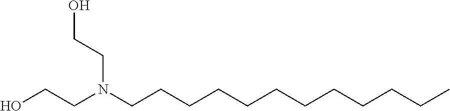 [SMILES: CCCCCCCCCCCCN(CCO)CCO] |

| | |
|---|---|
| 94 | 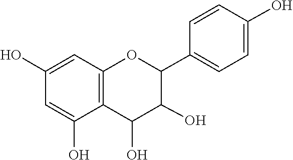 [SMILES: Oc1ccc(C2Oc3cc(O)cc(O)c3C(O)C2O)cc1] |

| | |
|---|---|
| 95 | 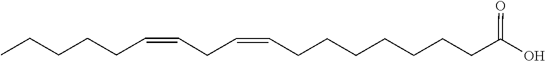 [SMILES: CCCCC/C=C\C/C=C\CCCCCCCC(=O)O] |
| 96 | 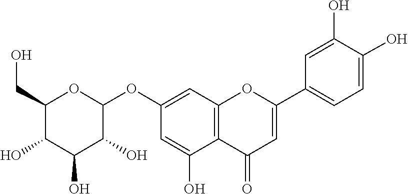 [SMILES: O=c1cc(-c2ccc(O)c(O)c2)oc2cc(OC3O[C@H](CO)[C@@H](O)[C@H](O)[C@H]3O)cc(O)c12] |
| 97 | 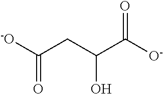 |

| | |
|---|---|
| 98 | 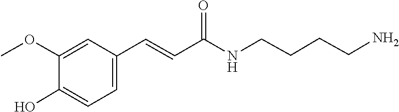 [SMILES: COc1cc(/C=C/C(=O)NCCCCN)ccc1O] |

| | |
|---|---|
| 99 | 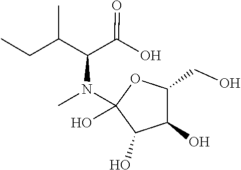 [SMILES: CCC(C)[C@@H](C(=O)O)N(C)C1(O)O[C@H](CO)[C@@H](O)[C@@H]1O] |
| 100 | 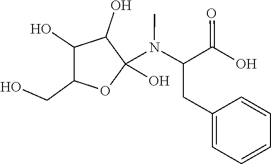 [SMILES: CN(C(Cc1ccccc1)C(=O)O)C1(O)OC(CO)C(O)C1O] |
| 101 | 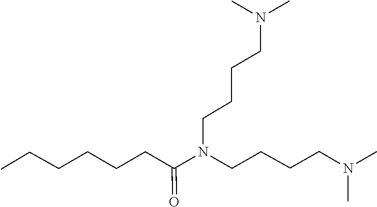 [SMILES: CCCCCCC(=O)N(CCCCN(C)C)CCCCN(C)C] |
| 102 | 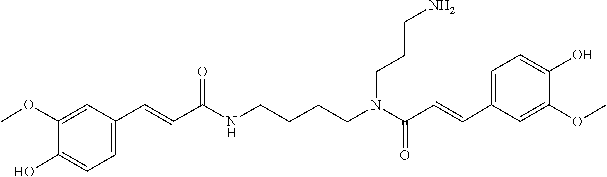 |
| 103 | 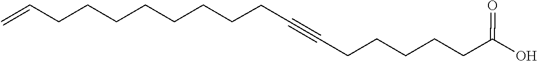 [SMILES: C=CCCCCCCCCC#CCCCCCC(=O)O] |
| 104 | 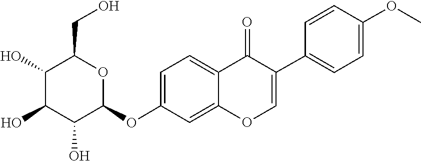 [SMILES: COc1ccc(-c2coc3cc(O[C@@H]4O[C@H](CO)[C@@H](O)[C@H](O)[C@H]4O)ccc3c2=O)cc1] |
| 105 | 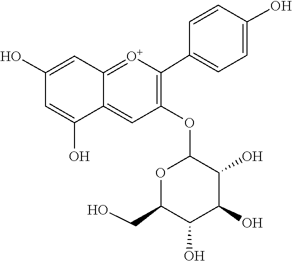 [SMILES: OC[C@H]1OC(Oc2cc3c(O)cc(O)cc3[o+]c2-c2ccc(O)cc2)[C@H](O)[C@@H](O)[C@@H]1O] |
| 106 | 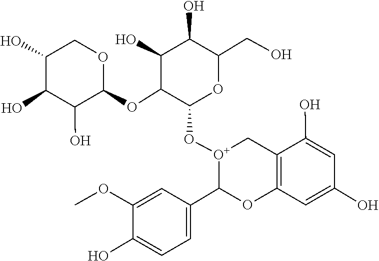 [SMILES: COc1cc(C2Oc3cc(O)cc(O)c3C[O+]2O[C@H]2OC(CO)[C@H](O)[C@H](O)C2O[C@@H]2OC[C@@H](O)[C@H](O)C2O)ccc1O] |
| 107 | 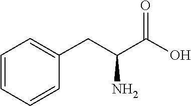 [SMILES: N[C@@H](Cc1ccccc1)C(=O)O] |
| 108 | 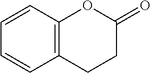 [SMILES: O=C1CCc2ccccc2O1] |
| 109 | 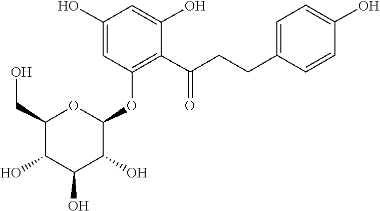 [SMILES: O=C(CCc1ccc(O)cc1)c1c(O)cc(O)cc1O[C@@H]1O[C@H](CO)[C@@H](O)[C@H](O)[C@H]1O] |
| 110 | 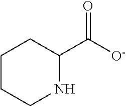 |
| 111 | 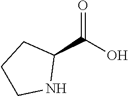 |
| 112 | 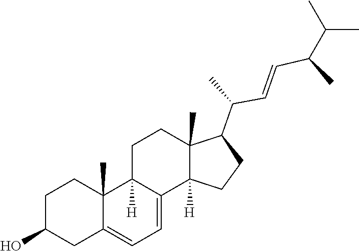 |
| 113 | 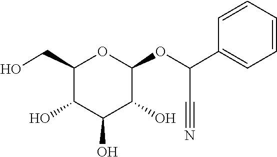 [SMILES: N#CC(O[C@@H]1O[C@H](CO)[C@@H](O)[C@H](O)[C@H]1O)c1ccccc1] |
| 114 | 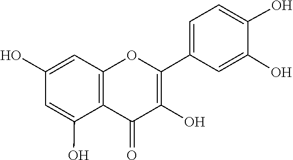 [SMILES: O=c1c(O)c(-c2ccc(O)c(O)c2)oc2cc(O)cc(O)c12] |
| 115 | 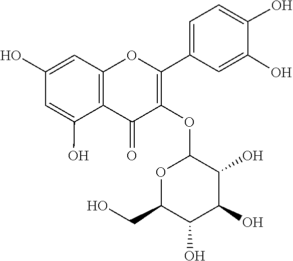 [SMILES: O=c1c(OC2O[C@H](CO)[C@@H](O)[C@H](O)[C@H]2O)c(-c2ccc(O)c(O)c2)oc2cc(O)cc(O)c12] |
| 116 | 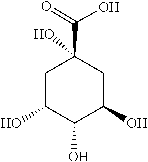 [SMILES: O=C(O)[C@]1(O)C[C@@H](O)[C@@H](O)[C@H](O)C1] |
| 117 | 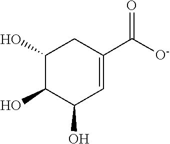 [SMILES: O=C([O-])C1=C[C@@H](O)[C@@H](O)[C@H](O)C1] |
| 118 | 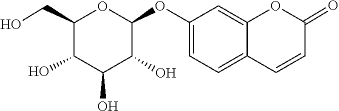 [SMILES: O=c1ccc2ccc(O[C@@H]3O[C@H](CO)[C@@H](O)[C@H](O)[C@H]3O)cc2o1] |
| 119 | 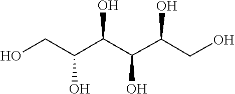 [SMILES: OC[C@@H](O)[C@@H](O)[C@H](O)[C@@H](O)CO] |
| 120 | 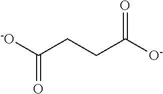 |
| 121 | 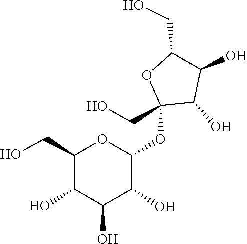 [SMILES: OC[C@H]1O[C@@](CO)(O[C@H]2O[C@H](CO)[C@@H](O)[C@H](O)[C@H]2O)[C@@H](O)[C@@H]1O] |
| 122 | 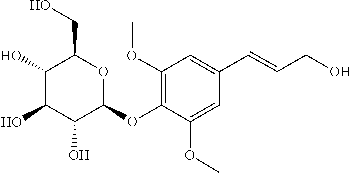 [SMILES: COc1cc(/C=C/CO)cc(OC)c1O[C@@H]1O[C@H](CO)[C@@H](O)[C@H](O)[C@H]1O] |
| 123 | 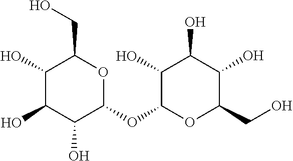 [SMILES: OC[C@H]1O[C@H](O[C@H]2O[C@H](CO)[C@@H](O)[C@H](O)[C@H]2O)[C@H](O)[C@@H](O)[C@@H]1O] |
| 124 | 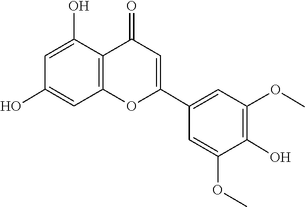 [SMILES: COc1cc(-c2cc(=O)c3c(O)cc(O)cc3o2)cc(OC)c1O] |
| 125 | 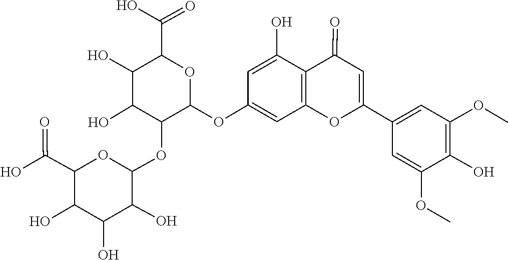 [SMILES: COc1cc(-c2cc(=O)c3c(O)cc(OC4OC(C(=O)O)C(O)C(O)C4OC4OC(C(=O)O)C(O)C(O)C4O)cc3o2)cc(OC)c1O] |
| 126 | 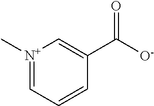 |
| 127 | 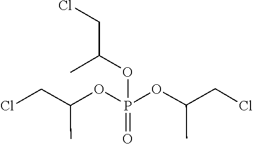 [SMILES: CC(CCl)OP(=O)(OC(C)CCl)OC(C)CCl] |
| 128 | 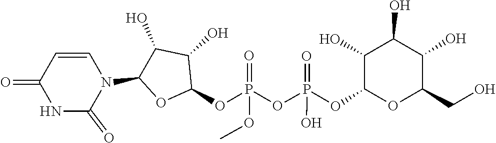 [SMILES: COP(=O)(O[C@H]1O[C@@H](n2ccc(=O)[nH]c2=O)[C@H](O)[C@@H]1O)OP(=O)(O)O[C@H]1O[C@H](CO)[C@@H](O)[C@H](O)[C@H]1O] |
| 129 | 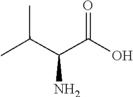 |
| 130 | 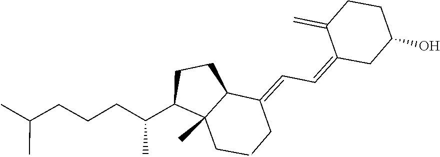 [SMILES: C=C1CC[C@H](O)C/C1=C/C=C(\CC)[C@@H]1CC[C@H]([C@H](C)CCCC(C)C)[C@@]1(C)CC] |

Table 7 shows volatile composition in the soluble phase in 1:2 proportions of Prunus persica extract to Zea mays extract determined by gas chromatography-mass spectrometry.

TABLE 7

| | | | Final |
|---|---|---|---|
| | | | Abundance |
| # | Compound | Source | % |
| 1 | (E,E)-2,4-Heptadienal | Peach | 0.032 |
| 2 | 1-Ethyl-2-formylpyrrole | Sweet corn | 0.206 |
| 3 | 1-Ethylpyrrole | Sweet corn | 0.061 |
| 4 | 1-Heptanol | Sweet corn | 2.403 |
| 5 | 1-Hexanol | Peach + | 1.983 |
| | | Sweet corn | |
| 6 | 1-Octanol | Peach + | 0.144 |
| | | Sweet corn | |
| 7 | 1-Octen-3-ol | Peach + | 0.516 |
| | | Sweet corn | |
| 8 | 1-Octen-3-one | Peach | 3.091 |
| 9 | 1-Pentanol | Peach + | 1.315 |
| | | Sweet corn | |
| 10 | 1,3-Ditertbutylbenzene | Sweet corn | 0.271 |
| 11 | 2-Butyl-2-octenal | Sweet corn | 6.361 |
| 12 | 2-Ethyl-3,5-dimethylpyrazine | Sweet corn | 0.133 |
| 13 | 2-Heptanone | Peach + | 0.051 |
| | | Sweet corn | |
| 14 | 2-Methyl-1-penten-3-one | Peach | 0.214 |
| 15 | 2-Methylbutanal | Sweet corn | 0.761 |
| 16 | 2-Methylbutanol | Peach | 30.607 |
| 17 | 2-Octanone | Sweet corn | 1.563 |
| 18 | 2-Pentylfuran | Peach + | 0.306 |
| | | Sweet corn | |
| 19 | 2-Phenylethanal | Peach + | 1.016 |
| | | Sweet corn | |
| 20 | 2-Phenylethanol | Peach | 0.351 |
| 21 | 2,3-Butanediol isomer 2 | Sweet corn | 0.234 |
| 22 | 2,3,5,6-Tetramethyl pyrazine | Sweet corn | 0.039 |
| 23 | 3-Methylbutanal | Sweet corn | 1.255 |
| 24 | 3-Octen-2-one | Sweet corn | 0.309 |
| 25 | 3,5-Octadien-2-one | Peach + | 0.030 |
| | | Sweet corn | |
| 26 | 4-Terpineol | Peach | 3.705 |
| 27 | 6-Methyl-5-hepten-2-one | Peach + | 0.124 |
| | | Sweet corn | |
| 28 | a-Ionone | Sweet corn | 0.229 |
| 29 | a-Terpineol | Peach | 0.255 |
| 30 | Acetophenone | Sweet corn | 9.782 |
| 31 | b-Cyclocitral | Peach | 0.071 |
| 32 | b-Ionone | Peach | 0.210 |
| 33 | b-Pinene | Sweet corn | 6.779 |
| 34 | Benzaldehyde | Peach + | 0.398 |
| | | Sweet corn | |
| 35 | D-Carvone | Peach | 0.266 |
| 36 | d-Decalactone | Peach | 0.093 |
| 37 | D-Limonene | Peach + | 0.237 |
| | | Sweet corn | |
| 38 | Dihydroactinidiolide | Peach | 0.058 |
| 39 | Dimethyl disulfide | Sweet corn | 0.117 |
| 40 | Dimethyl trisulfide | Sweet corn | 0.436 |
| 41 | E-2-Heptenal | Peach + | 0.089 |
| | | Sweet corn | |
| 42 | E-2-Hexenal | Peach | 2.626 |
| 43 | E-2-Octen-1-ol | Peach | 0.979 |
| 44 | E-2-Octenal | Peach + | 0.689 |
| | | Sweet corn | |
| 45 | E-2-Undecenal | Peach | 0.149 |
| 46 | Ethyl pyrazine | Sweet corn | 0.897 |
| 47 | Furfural | Peach | 0.270 |
| 48 | g-Decalactone | Peach | 0.816 |
| 49 | Geranyl acetone | Peach + | 0.853 |
| | | Sweet corn | |
| 50 | Heptanal | Peach + | 0.288 |
| | | Sweet corn | |
| 51 | Hexanal | Peach + | 0.089 |
| | | Sweet corn | |
| 52 | Hexanoic acid | Sweet corn | 1.001 |
| 53 | Isoamyl alcohol | Peach | 0.150 |
| 54 | Isovaleric acid | Peach | 1.095 |
| 55 | Linalool | Peach | 0.372 |
| 56 | m-Xylene | Sweet corn | 0.149 |
| 57 | Naphthalene | Peach + | 0.788 |
| | | Sweet corn | |
| 58 | Nonanal | Peach + | 1.934 |
| | | Sweet corn | |
| 59 | o-Xylene | Sweet corn | 1.918 |
| 60 | Octanal | Peach + | 6.088 |
| | | Sweet corn | |
| 61 | p-Cymenene | Peach | 0.472 |
| 62 | p-Xylene | Sweet corn | 0.577 |
| 63 | Pentanal | Peach + | 0.473 |
| | | Sweet corn | |
| 64 | Pentanoic acid | Peach | 0.467 |
| 65 | Vanillin | Sweet corn | 0.361 |
| 66 | Z-4-Heptenal | Peach | 0.398 |

Table 8 shows chemical structures in volatile phase.

| # | Chemical Structure |
|---|---|
| 1 | 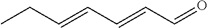 |
| 2 | 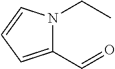 |
| 3 | 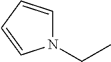 |
| 4 | 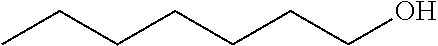 |
| 5 | 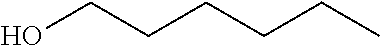 |
| 6 | 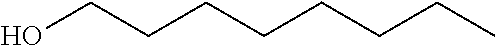 |
| 7 | 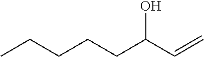 |
| 8 | 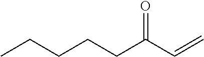 |
| 9 | 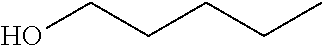 |
| 10 | 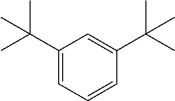 |
| 11 | 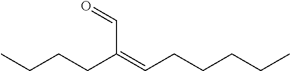 |
| 12 | 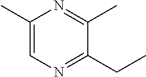 |
| 13 | 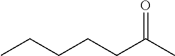 |
| 14 | 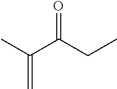 |
| 15 | 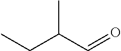 |
| 16 | 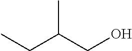 |
| 17 | 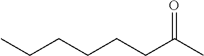 |
| 18 | 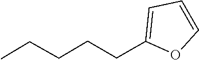 |
| 19 | 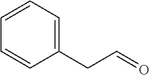 |
| 20 | 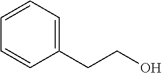 |
| 21 | 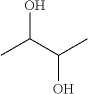 |
| 22 | 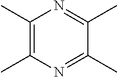 |
| 23 | 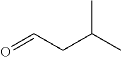 |
| 24 | 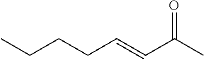 |
| 25 | 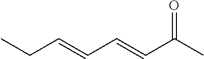 |
| 26 | 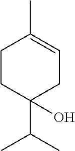 |
| 27 | 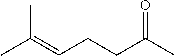 |
| 28 | 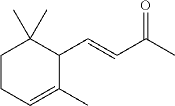 |
| 29 | 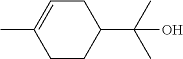 |
| 30 | 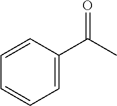 |
| 31 | 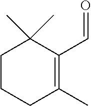 |
| 32 | 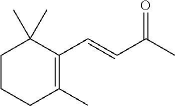 |
| 33 | 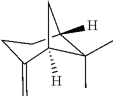 |
| 34 | 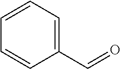 |
| 35 | 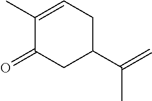 |
| 36 | 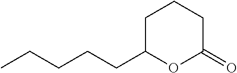 |
| 37 | 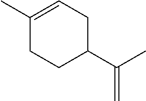 |
| 38 | 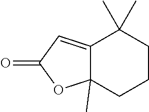 |
| 39 | 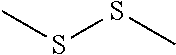 |
| 40 | 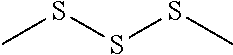 |
| 41 | 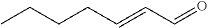 |
| 42 | 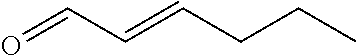 |
| 43 | 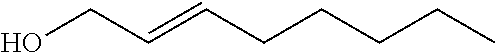 |
| 44 | 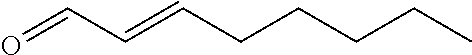 |
| 45 | 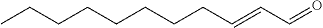 |
| 46 | 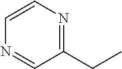 |
| 47 | 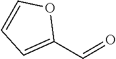 |
| 48 | 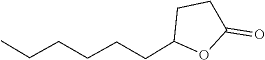 |
| 49 | 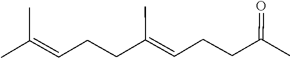 |
| 50 | 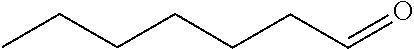 |
| 51 | 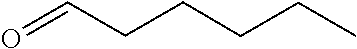 |
| 52 | 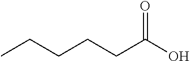 |
| 53 | 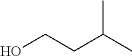 |
| 54 | 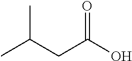 |
| 55 | 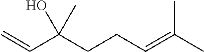 |
| 56 | 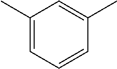 |
| 57 | 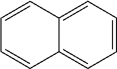 |
| 58 | 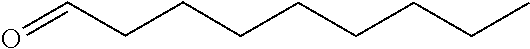 |
| 59 | 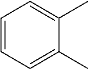 |
| 60 | 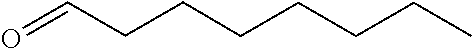 |
| 61 | 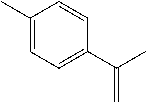 |
| 62 | 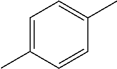 |
| 63 | 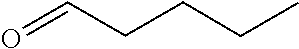 |
| 64 | 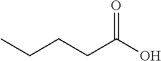 |
| 65 | 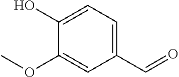 |
| 66 | 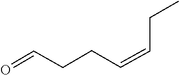 |

The molecules found in the flavoring agent having the ratio 1:2 of a Prunus persica component and a Zea mays component reveal a chemical explanation as to why both ingredients mimic a chicken-like flavor. As discussed herein, using AI/ML techniques, the system predicts ingredients that mimic a flavor of a target food item (e.g., cooked chicken). Chemical analysis reveal that the composition of the flavoring agent share molecules (or functional groups/families of chemical structures) with cooked chicken. Such molecules include sulfur compounds in the soluble fraction (e.g., Tables 5 and 6, #74) and volatile fraction (e.g., Tables 7 and 8, #39 and #40); heterocyclic compounds such as pyrazine and pyrrole derivatives; alcohol and aldehyde compounds derived from oxidation of lipids, lipids identified in the soluble fraction and their derivatives identified in the volatile fraction such as hexanal, heptanal, and octen-1-ol; and, other molecules such as amino acids (e.g., Valine (Tables 5 and 6, #129); Proline (Tables 5 and 6, #111); Tyrosine (Tables 5 and 6, #92); Asparagine (Tables 5 and 6, #91); isoleucine (Tables 5 and 6, #89); glutamine (Tables 5 and 6, #83); glutamate (Tables 5 and 6, #82); alanine (Tables 5 and 6, #46)), nucleotides (e.g., Adenosine (Tables 5 and 6, #45)), N-containing compounds (e.g., Tables 5 and 6, #18, #47, #66; Tables 7 and 8, #22 and #46), b-ionone (e.g., Tables 7 and 8, #32) and lactones (e.g., Tables 7 and 8, #36 and #48).

Table 9 shows volatile compounds in the target food item (e.g., cooked chicken) determined by gas chromatography-mass spectrometry. FIG. 6F illustrates a FTIR spectrum of the target food item. The highlighted compounds in Table 9 are shared with the flavoring agent having the 1:2 proportions of Prunus persica extract to Zea mays extract.

TABLE 9

| Chicken Volatiles | % |
|---|---|
| 1-Ethylpyrrole | 1.94 |
| 1-Heptanol | 1.67 |
| 1-Octanol | 1.55 |
| 1-Octen-3-ol | 6.68 |
| 2-Acetylpyrrole | 1.61 |
| 2-Ethyl-3,5-dimethylpyrazine | 6.48 |
| 2-Ethyl-3,5-dimethylpyrazine | 2.85 |
| 2-Ethyl-5-methylpyrazine | 1.60 |
| 2-Ethyl-6-methylpyrazine | 0.50 |
| 2-Ethylhexanol | 0.66 |
| 2-Heptanone | 1.95 |
| 2-Methylbutanal | 1.78 |
| 2-Methylbutanol | 1.35 |
| 2-Methylpyrazine | 2.49 |
| 2-Octanone | 1.13 |
| 2-Pentylfuran | 2.51 |
| 2,3-Dimethylpyrazine | 13.54 |
| 2,3,5-Trimethylpyrazine | 3.14 |
| 2,3,5,6-Tetramethyl pyrazine | 2.89 |
| 2,5-Dimethylpyrazine | 1.45 |
| 2,6-Di-tert-butyl-p-cresol | 1.64 |
| 2,6-Diethylpyrazine | 2.40 |
| 2,6-Dimethylpyrazine | 1.64 |
| 3-Methylbutanal | 12.50 |
| 3,5-Di-tert-butyl-4-hydroxybenzaldehyde | 2.31 |
| 3,5-Di-tert-butyl-4-hydroxybenzyl alcohol | 0.67 |
| 4-Nonanone | 4.35 |
| b-Ionone | 0.45 |
| Benzaldehyde | 1.94 |
| Benzothiazole | 0.89 |
| Decanoic acid | 0.64 |
| Ethyl octanoate | 1.42 |
| Heptanal | 4.40 |
| Hexanal | 1.22 |
| Hexanoic acid | 2.95 |
| Nonanal | 0.35 |
| o-Xylene | 1.40 |
| Octanal | 1.08 |
| Vanillin | 1.94 |

Embodiments of the plant-based chicken flavoring agent can function to reduce the consequences associated with production and consumption of animal-based foods (e.g., chicken), where such consequences can include animal cruelty, greenhouse gas emissions, water use, deforestation, pollution, human health conditions, allergies and/or other suitable consequences.

### 6.0 HARDWARE OVERVIEW

According to one embodiment, the techniques described herein are implemented by at least one computing device. The techniques may be implemented in whole or in part using a combination of at least one server computer and/or other computing devices that are coupled using a network, such as a packet data network. The computing devices may be hard-wired to perform the techniques or may include digital electronic devices such as at least one application-specific integrated circuit (ASIC) or field programmable gate array (FPGA) that is persistently programmed to perform the techniques or may include at least one general purpose hardware processor programmed to perform the techniques pursuant to program instructions in firmware, memory, other storage, or a combination. Such computing devices may also combine custom hard-wired logic, ASICs, or FPGAs with custom programming to accomplish the described techniques. The computing devices may be server computers, workstations, personal computers, portable computer systems, handheld devices, mobile computing devices, wearable devices, body mounted or implantable devices, smartphones, smart appliances, internetworking devices, autonomous or semi-autonomous devices such as robots or unmanned ground or aerial vehicles, any other electronic device that incorporates hard-wired and/or program logic to implement the described techniques, one or more virtual computing machines or instances in a data center, and/or a network of server computers and/or personal computers.

FIG. 7 is a block diagram that illustrates an example computer system with which an embodiment may be implemented. In the example of FIG. 7, a computer system 700 and instructions for implementing the disclosed technologies in hardware, software, or a combination of hardware and software, are represented schematically, for example as boxes and circles, at the same level of detail that is commonly used by persons of ordinary skill in the art to which this disclosure pertains for communicating about computer architecture and computer systems implementations.

Computer system 700 includes an input/output (I/O) subsystem 702 which may include a bus and/or other communication mechanism(s) for communicating information and/or instructions between the components of the computer system 700 over electronic signal paths. The I/O subsystem 702 may include an I/O controller, a memory controller and at least one I/O port. The electronic signal paths are represented schematically in the drawings, for example as lines, unidirectional arrows, or bidirectional arrows.

At least one hardware processor 704 is coupled to I/O subsystem 702 for processing information and instructions. Hardware processor 704 may include, for example, a general-purpose microprocessor or microcontroller and/or a special-purpose microprocessor such as an embedded system or a graphics processing unit (GPU) or a digital signal processor or ARM processor. Processor 704 may comprise an integrated arithmetic logic unit (ALU) or may be coupled to a separate ALU.

Computer system 700 includes one or more units of memory 706, such as a main memory, which is coupled to I/O subsystem 702 for electronically digitally storing data and instructions to be executed by processor 704. Memory 706 may include volatile memory such as various forms of random-access memory (RAM) or other dynamic storage device. Memory 706 also may be used for storing temporary variables or other intermediate information during execution of instructions to be executed by processor 704. Such instructions, when stored in non-transitory computer-readable storage media accessible to processor 704, can render computer system 700 into a special-purpose machine that is customized to perform the operations specified in the instructions.

Computer system 700 further includes non-volatile memory such as read only memory (ROM) 708 or other static storage device coupled to I/O subsystem 702 for storing information and instructions for processor 704. The ROM 708 may include various forms of programmable ROM (PROM) such as erasable PROM (EPROM) or electrically erasable PROM (EEPROM). A unit of persistent storage 710 may include various forms of non-volatile RAM (NVRAM), such as FLASH memory, or solid-state storage, magnetic disk, or optical disk such as CD-ROM or DVD-ROM and may be coupled to I/O subsystem 702 for storing information and instructions. Storage 710 is an example of a non-transitory computer-readable medium that may be used to store instructions and data which when executed by the processor 704 cause performing computer-implemented methods to execute the techniques herein.

The instructions in memory 706, ROM 708 or storage 710 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. The instructions may implement a web server, web application server or web client. The instructions may be organized as a presentation layer, application layer and data storage layer such as a relational database system using structured query language (SQL) or no SQL, an object store, a graph database, a flat file system or other data storage.

Computer system 700 may be coupled via I/O subsystem 702 to at least one output device 712. In one embodiment, output device 712 is a digital computer display. Examples of a display that may be used in various embodiments include a touch screen display or a light-emitting diode (LED) display or a liquid crystal display (LCD) or an e-paper display. Computer system 700 may include other type(s) of output devices 712, alternatively or in addition to a display device. Examples of other output devices 712 include printers, ticket printers, plotters, projectors, sound cards or video cards, speakers, buzzers or piezoelectric devices or other audible devices, lamps or LED or LCD indicators, haptic devices, actuators, or servos.

At least one input device 714 is coupled to I/O subsystem 702 for communicating signals, data, command selections or gestures to processor 704. Examples of input devices 714 include touch screens, microphones, still and video digital cameras, alphanumeric and other keys, keypads, keyboards, graphics tablets, image scanners, joysticks, clocks, switches, buttons, dials, slides, and/or various types of sensors such as force sensors, motion sensors, heat sensors, accelerometers, gyroscopes, and inertial measurement unit (IMU) sensors and/or various types of transceivers such as wireless, such as cellular or Wi-Fi, radio frequency (RF) or infrared (IR) transceivers and Global Positioning System (GPS) transceivers.

Another type of input device is a control device 716, which may perform cursor control or other automated control functions such as navigation in a graphical interface on a display screen, alternatively or in addition to input functions. Control device 716 may be a touchpad, a mouse, a trackball, or cursor direction keys for communicating direction information and command selections to processor 704 and for controlling cursor movement on display 712. The input device may have at least two degrees of freedom in two axes, a first axis (e.g., x) and a second axis (e.g., y), that allows the device to specify positions in a plane. Another type of input device is a wired, wireless, or optical control device such as a joystick, wand, console, steering wheel, pedal, gearshift mechanism or other type of control device. An input device 714 may include a combination of multiple different input devices, such as a video camera and a depth sensor.

In another embodiment, computer system 700 may comprise an internet of things (IoT) device in which one or more of the output device 712, input device 714, and control device 716 are omitted. Or, in such an embodiment, the input device 714 may comprise one or more cameras, motion detectors, thermometers, microphones, seismic detectors, other sensors or detectors, measurement devices or encoders and the output device 712 may comprise a special-purpose display such as a single-line LED or LCD display, one or more indicators, a display panel, a meter, a valve, a solenoid, an actuator or a servo.

When computer system 700 is a mobile computing device, input device 714 may comprise a global positioning system (GPS) receiver coupled to a GPS module that is capable of triangulating to a plurality of GPS satellites, determining and generating geo-location or position data such as latitude-longitude values for a geophysical location of the computer system 700. Output device 712 may include hardware, software, firmware and interfaces for generating position reporting packets, notifications, pulse or heartbeat signals, or other recurring data transmissions that specify a position of the computer system 700, alone or in combination with other application-specific data, directed toward host 724 or server 730.

Computer system 700 may implement the techniques described herein using customized hard-wired logic, at least one ASIC or FPGA, firmware and/or program instructions or logic which when loaded and used or executed in combination with the computer system causes or programs the computer system to operate as a special-purpose machine. According to one embodiment, the techniques herein are performed by computer system 700 in response to processor 704 executing at least one sequence of at least one instruction contained in main memory 706. Such instructions may be read into main memory 706 from another storage medium, such as storage 710. Execution of the sequences of instructions contained in main memory 706 causes processor 704 to perform the process steps described herein. In alternative embodiments, hard-wired circuitry may be used in place of or in combination with software instructions.

The term “storage media” as used herein refers to any non-transitory media that store data and/or instructions that cause a machine to operation in a specific fashion. Such storage media may comprise non-volatile media and/or volatile media. Non-volatile media includes, for example, optical or magnetic disks, such as storage 710. Volatile media includes dynamic memory, such as memory 706. Common forms of storage media include, for example, a hard disk, solid state drive, flash drive, magnetic data storage medium, any optical or physical data storage medium, memory chip, or the like.

Storage media is distinct from but may be used in conjunction with transmission media. Transmission media participates in transferring information between storage media. For example, transmission media includes coaxial cables, copper wire and fiber optics, including the wires that comprise a bus of I/O subsystem 702. Transmission media can also take the form of acoustic or light waves, such as those generated during radio-wave and infra-red data communications.

Various forms of media may be involved in carrying at least one sequence of at least one instruction to processor 704 for execution. For example, the instructions may initially be carried on a magnetic disk or solid-state drive of a remote computer. The remote computer can load the instructions into its dynamic memory and send the instructions over a communication link such as a fiber optic or coaxial cable or telephone line using a modem. A modem or router local to computer system 700 can receive the data on the communication link and convert the data to a format that can be read by computer system 700. For instance, a receiver such as a radio frequency antenna or an infrared detector can receive the data carried in a wireless or optical signal and appropriate circuitry can provide the data to I/O subsystem 702 such as place the data on a bus. I/O subsystem 702 carries the data to memory 706, from which processor 704 retrieves and executes the instructions. The instructions received by memory 706 may optionally be stored on storage 710 either before or after execution by processor 704.

Computer system 700 also includes a communication interface 718 coupled to bus 702. Communication interface 718 provides a two-way data communication coupling to network link(s) 720 that are directly or indirectly connected to at least one communication networks, such as a network 722 or a public or private cloud on the Internet. For example, communication interface 718 may be an Ethernet networking interface, integrated-services digital network (ISDN) card, cable modem, satellite modem, or a modem to provide a data communication connection to a corresponding type of communications line, for example an Ethernet cable or a metal cable of any kind or a fiber-optic line or a telephone line. Network 722 broadly represents a local area network (LAN), wide-area network (WAN), campus network, internetwork, or any combination thereof. Communication interface 718 may comprise a LAN card to provide a data communication connection to a compatible LAN, or a cellular radiotelephone interface that is wired to send or receive cellular data according to cellular radiotelephone wireless networking standards, or a satellite radio interface that is wired to send or receive digital data according to satellite wireless networking standards. In any such implementation, communication interface 718 sends and receives electrical, electromagnetic, or optical signals over signal paths that carry digital data streams representing various types of information.

Network link 720 typically provides electrical, electromagnetic, or optical data communication directly or through at least one network to other data devices, using, for example, satellite, cellular, Wi-Fi, or BLUETOOTH technology. For example, network link 720 may provide a connection through a network 722 to a host computer 724.

Furthermore, network link 720 may provide a connection through network 722 or to other computing devices via internetworking devices and/or computers that are operated by an Internet Service Provider (ISP) 726. ISP 726 provides data communication services through a world-wide packet data communication network represented as internet 728. A server computer 730 may be coupled to internet 728. Server 730 broadly represents any computer, data center, virtual machine, or virtual computing instance with or without a hypervisor, or computer executing a containerized program system such as DOCKER or KUBERNETES. Server 730 may represent an electronic digital service that is implemented using more than one computer or instance and that is accessed and used by transmitting web services requests, uniform resource locator (URL) strings with parameters in HTTP payloads, API calls, app services calls, or other service calls. Computer system 700 and server 730 may form elements of a distributed computing system that includes other computers, a processing cluster, server farm or other organization of computers that cooperate to perform tasks or execute applications or services. Server 730 may comprise one or more sets of instructions that are organized as modules, methods, objects, functions, routines, or calls. The instructions may be organized as one or more computer programs, operating system services, or application programs including mobile apps. The instructions may comprise an operating system and/or system software; one or more libraries to support multimedia, programming or other functions; data protocol instructions or stacks to implement TCP/IP, HTTP or other communication protocols; file format processing instructions to parse or render files coded using HTML, XML, JPEG, MPEG or PNG; user interface instructions to render or interpret commands for a graphical user interface (GUI), command-line interface or text user interface; application software such as an office suite, internet access applications, design and manufacturing applications, graphics applications, audio applications, software engineering applications, educational applications, games or miscellaneous applications. Server 730 may comprise a web application server that hosts a presentation layer, application layer and data storage layer such as a relational database system using structured query language (SQL) or no SQL, an object store, a graph database, a flat file system or other data storage.

Computer system 700 can send messages and receive data and instructions, including program code, through the network(s), network link 720 and communication interface 718. In the Internet example, a server 730 might transmit a requested code for an application program through Internet 728, ISP 726, local network 722 and communication interface 718. The received code may be executed by processor 704 as it is received, and/or stored in storage 710, or other non-volatile storage for later execution.

The execution of instructions as described in this section may implement a process in the form of an instance of a computer program that is being executed and consisting of program code and its current activity. Depending on the operating system (OS), a process may be made up of multiple threads of execution that execute instructions concurrently. In this context, a computer program is a passive collection of instructions, while a process may be the actual execution of those instructions. Several processes may be associated with the same program; for example, opening up several instances of the same program often means more than one process is being executed. Multitasking may be implemented to allow multiple processes to share processor 704. While each processor 704 or core of the processor executes a single task at a time, computer system 700 may be programmed to implement multitasking to allow each processor to switch between tasks that are being executed without having to wait for each task to finish. In an embodiment, switches may be performed when tasks perform input/output operations, when a task indicates that it can be switched, or on hardware interrupts. Time-sharing may be implemented to allow fast response for interactive user applications by rapidly performing context switches to provide the appearance of concurrent execution of multiple processes simultaneously. In an embodiment, for security and reliability, an operating system may prevent direct communication between independent processes, providing strictly mediated and controlled inter-process communication functionality.

### 6.0 SOFTWARE OVERVIEW

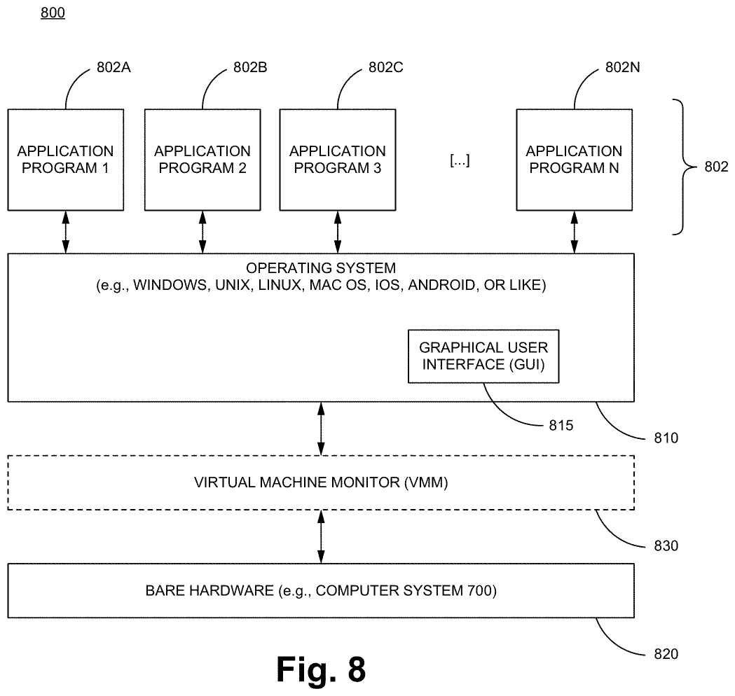

FIG. 8 is a block diagram of a basic software system 800 that may be employed for controlling the operation of computing device 700. Software system 800 and its components, including their connections, relationships, and functions, is meant to be exemplary only, and not meant to limit implementations of the example embodiment(s). Other software systems suitable for implementing the example embodiment(s) may have different components, including components with different connections, relationships, and functions.

Software system 800 is provided for directing the operation of computing device 700. Software system 800, which may be stored in system memory (RAM) 706 and on fixed storage (e.g., hard disk or flash memory) 710, includes a kernel or operating system (OS) 810.

The OS 810 manages low-level aspects of computer operation, including managing execution of processes, memory allocation, file input and output (I/O), and device I/O. One or more application programs, represented as 802A, 802B, 802C . . . 802N, may be “loaded” (e.g., transferred from fixed storage 710 into memory 706) for execution by the system 800. The applications or other software intended for use on device 800 may also be stored as a set of downloadable computer-executable instructions, for example, for downloading and installation from an Internet location (e.g., a Web server, an app store, or other online service).

Software system 800 includes a graphical user interface (GUI) 815, for receiving user commands and data in a graphical (e.g., “point-and-click” or “touch gesture”) fashion. These inputs, in turn, may be acted upon by the system 800 in accordance with instructions from operating system 810 and/or application(s) 802. The GUI 815 also serves to display the results of operation from the OS 810 and application(s) 802, whereupon the user may supply additional inputs or terminate the session (e.g., log off).

OS 810 can execute directly on the bare hardware 820 (e.g., processor(s) 704) of device 700. Alternatively, a hypervisor or virtual machine monitor (VMM) 830 may be interposed between the bare hardware 820 and the OS 810. In this configuration, VMM 830 acts as a software “cushion” or virtualization layer between the OS 810 and the bare hardware 820 of the device 700.

VMM 830 instantiates and runs one or more virtual machine instances (“guest machines”). Each guest machine comprises a “guest” operating system, such as OS 810, and one or more applications, such as application(s) 802, designed to execute on the guest operating system. The VMM 830 presents the guest operating systems with a virtual operating platform and manages the execution of the guest operating systems.

In some instances, the VMM 830 may allow a guest operating system to run as if it is running on the bare hardware 820 of device 700 directly. In these instances, the same version of the guest operating system configured to execute on the bare hardware 820 directly may also execute on VMM 830 without modification or reconfiguration. In other words, VMM 830 may provide full hardware and CPU virtualization to a guest operating system in some instances.

In other instances, a guest operating system may be specially designed or configured to execute on VMM 830 for efficiency. In these instances, the guest operating system is “aware” that it executes on a virtual machine monitor. In other words, VMM 830 may provide para-virtualization to a guest operating system in some instances.

The above-described basic computer hardware and software is presented for purpose of illustrating the basic underlying computer components that may be employed for implementing the example embodiment(s). The example embodiment(s), however, are not necessarily limited to any particular computing environment or computing device configuration. Instead, the example embodiment(s) may be implemented in any type of system architecture or processing environment that one skilled in the art, in light of this disclosure, would understand as capable of supporting the features and functions of the example embodiment(s) presented herein.

### 8.0 OTHER ASPECTS OF DISCLOSURE

Note that the embodiments described herein relate to the flavors of the ingredients in the formula. However, it will be noted that the use of methods and systems described herein can be extended to classify texture, color, aftertaste and/or acceptance (e.g., for tasting a sample) for the formulas within the scope of the disclosed technologies.

In certain embodiments, flavor classifiers (e.g., for determining flavor categories), flavor predictors (e.g., for determining flavor descriptors), taste models (e.g., for determining taste levels), and/or other suitable models, suitable components of embodiments of the system 100, and/or suitable portions of embodiments of methods described herein can include, apply, employ, perform, use, be based on, and/or otherwise be associated with artificial intelligence approaches (e.g., machine learning approaches, etc.) including any one or more of: supervised learning (e.g., using gradient boosting trees, using logistic regression, using back propagation neural networks, using random forests, decision trees, etc.), unsupervised learning (e.g., using an Apriori algorithm, using K-means clustering), semi-supervised learning, a deep learning algorithm (e.g., neural networks, a restricted Boltzmann machine, a deep belief network method, a convolutional neural network method, a recurrent neural network method, stacked auto-encoder method, etc.), reinforcement learning (e.g., using a Q-learning algorithm, using temporal difference learning), a regression algorithm (e.g., ordinary least squares, logistic regression, stepwise regression, multivariate adaptive regression splines, locally estimated scatterplot smoothing, etc.), an instance-based method (e.g., k-nearest neighbor, learning vector quantization, self-organizing map, etc.), a regularization method (e.g., ridge regression, least absolute shrinkage and selection operator, elastic net, etc.), a decision tree learning method (e.g., classification and regression tree, iterative dichotomiser 3, C4.5, chi-squared automatic interaction detection, decision stump, random forest, multivariate adaptive regression splines, gradient boosting machines, etc.), a Bayesian method (e.g., naïve Bayes, averaged one-dependence estimators, Bayesian belief network, etc.), a kernel method (e.g., a support vector machine, a radial basis function, a linear discriminant analysis, etc.), a clustering method (e.g., k-means clustering, expectation maximization, etc.), an associated rule learning algorithm (e.g., an Apriori algorithm, an Eclat algorithm, etc.), an artificial neural network model (e.g., a Perceptron method, a back-propagation method, a Hopfield network method, a self-organizing map method, a learning vector quantization method, etc.), a dimensionality reduction method (e.g., principal component analysis, partial least squares regression, Sammon mapping, multidimensional scaling, projection pursuit, etc.), an ensemble method (e.g., boosting, bootstrapped aggregation, AdaBoost, stacked generalization, gradient boosting machine method, random forest method, etc.), and/or any suitable artificial intelligence approach.

Models described herein can be run or updated: once; at a predetermined frequency; every time a certain process is performed; every time a trigger condition is satisfied and/or at any other suitable time and frequency. Models can be run or updated concurrently with one or more other models, serially, at varying frequencies, and/or at any other suitable time. Each model can be validated, verified, reinforced, calibrated, or otherwise updated based on newly received, up-to-date data; historical data or be updated based on any other suitable data.

Portions of embodiments of methods and/or systems described herein are preferably performed by a first party but can additionally or alternatively be performed by one or more third parties, users, and/or any suitable entities.

Additionally or alternatively, data described herein can be associated with any suitable temporal indicators (e.g., seconds, minutes, hours, days, weeks, time periods, time points, timestamps, etc.) including one or more: temporal indicators indicating when the data was collected, determined (e.g., output by a model described herein), transmitted, received, and/or otherwise processed; temporal indicators providing context to content described by the data; changes in temporal indicators (e.g., data over time; change in data; data patterns; data trends; data extrapolation and/or other prediction; etc.); and/or any other suitable indicators related to time.

Additionally or alternatively, parameters, metrics, inputs (e.g., formulas, ingredient attributes, other suitable features, etc.), outputs (e.g., flavor categories, flavor descriptors, other suitable flavor classes, taste levels, etc.), and/or other suitable data can be associated with value types including any one or more of: scores (e.g., certainty levels, taste level, etc.), text values (e.g., flavor descriptors, verbal descriptions of ingredients, etc.), numerical values, binary values, classifications, confidence levels, identifiers, values along a spectrum, and/or any other suitable types of values. Any suitable types of data described herein can be used as inputs (e.g., for different models described herein; for components of a system; etc.), generated as outputs (e.g., of models; of components of a system; etc.), and/or manipulated in any suitable manner for any suitable components.

Additionally or alternatively, suitable portions of embodiments of methods and/or systems described herein can include, apply, employ, perform, use, be based on, and/or otherwise be associated with one or more processing operations including any one or more of: extracting features, performing pattern recognition on data, fusing data from multiple sources, combination of values (e.g., averaging values, etc.), compression, conversion (e.g., digital-to-analog conversion, analog-to-digital conversion), performing statistical estimation on data (e.g. ordinary least squares regression, non-negative least squares regression, principal components analysis, ridge regression, etc.), normalization, updating, ranking, weighting, validating, filtering (e.g., for baseline correction, data cropping, etc.), noise reduction, smoothing, filling (e.g., gap filling), aligning, model fitting, binning, windowing, clipping, transformations, mathematical operations (e.g., derivatives, moving averages, summing, subtracting, multiplying, dividing, etc.), data association, interpolating, extrapolating, clustering, image processing techniques, other signal processing operations, other image processing operations, visualizing, and/or any other suitable processing operations.

Although some of the figures described in the foregoing specification include flow diagrams with steps that are shown in an order, the steps may be performed in any order, and are not limited to the order shown in those flowcharts. Additionally, some steps may be optional, may be performed multiple times, and/or may be performed by different components. All steps, operations and functions of a flow diagram that are described herein are intended to indicate operations that are performed using programming in a special-purpose computer or general-purpose computer, in various embodiments. In other words, each flow diagram in this disclosure, in combination with the related text herein, is a guide, plan or specification of all or part of an algorithm for programming a computer to execute the functions that are described. The level of skill in the field associated with this disclosure is known to be high, and therefore the flow diagrams and related text in this disclosure have been prepared to convey information at a level of sufficiency and detail that is normally expected in the field when skilled persons communicate among themselves with respect to programs, algorithms and their implementation.

In the foregoing specification, the example embodiment(s) of the present invention have been described with reference to numerous specific details. However, the details may vary from implementation to implementation according to the requirements of the particular implement at hand. The example embodiment(s) are, accordingly, to be regarded in an illustrative rather than a restrictive sense.

What is claimed is:

1. A plant-based composition comprising:
a plant-based chicken flavoring agent comprising:
a Prunus persica component;
a Zea mays component;
wherein the plant-based chicken flavoring agent replicates one or more sensorial descriptors of cooked chicken.

2. The plant-based composition of claim 1, wherein the one or more sensorial descriptors is at least one of aroma and flavor.

3. The plant-based composition of claim 1, wherein the Prunus persica component includes an aqueous extract of Prunus persica.

4. The plant-based composition of claim 1, wherein the Zea mays component includes an aqueous extract of Zea mays.

5. The plant-based composition of claim 1, wherein a ratio of the Prunus persica component to the Zea mays component of the plant-based chicken flavoring agent is one to an amount within a range of 1.8 to 2.2.

6. The plant-based composition of claim 1, further comprising a plant-based food product, wherein the plant-based chicken flavoring agent masks a flavor of the plant-based food product.

7. A method of manufacturing a plant-based composition, comprising:
preparing a plant-based chicken flavoring agent, wherein preparing the plant-based chicken flavoring agent includes:
preparing a Prunus persica component;
preparing a Zea mays component;
combining at least the Prunus persica component and the Zea mays component into a first homogeneous mixture;
wherein the homogeneous mixture replicates one or more sensorial descriptors of cooked chicken.

8. The method of claim 7, wherein the Prunus persica component and the Zea mays component are prepared using an aqueous extraction process.

9. The method of claim 8, wherein the aqueous extraction process comprises:
gathering a plant-based ingredient;
combining the plant-based ingredient with pure water in a second homogenous mixture;
filtering the mixture to obtain an extract of the plant-based ingredient;

10. The method of claim 9, wherein the extract is freeze dried.

11. The method of claim 9, wherein a ratio of the plant-based ingredient to pure water is one to an amount within a range of 1.5 and 2.5.

12. The method of claim 9, wherein the plant-based ingredient is Prunus persica or Zea mays.

13. The method of claim 7, wherein the one or more sensorial descriptors is at least one of aroma and flavor.

14. The method of claim 7, wherein the Prunus persica component includes a freeze dried aqueous extract of Prunus persica.

15. The method of claim 7, wherein the Zea mays component includes a freeze dried aqueous extract of Zea mays.

16. The method of claim 7, wherein a ratio of the Prunus persica component to the Zea mays component is one to an amount within a range of 1.8 to 2.2.

17. The method of claim 7, wherein the first homogeneous mixture includes one or more sensorial descriptors that each mimics a corresponding sensory feature of chicken.

18. The method of claim 7, further comprising gathering base ingredients of a plant-based meat item, wherein the base ingredients, the Prunus persica component, and the Zea mays component are combined into the first homogeneous mixture.

19. The method of claim 18, wherein the Prunus persica component and the Zea mays component together is one of 0.0015-0.030% and 0.003-0.018% w/w of the plant-based composition.

20. The method of claim 18, wherein the plant-based chicken flavoring agent masks a flavor of the plant-based meat item.
